(19) United States
(12) Patent Application Publication
(10) Pub. No.: US 2025/0047347 A1
(43) Pub. Date: Feb. 6, 2025

(54) TIME DIVISION MULTIPLEXED RESOURCE SELECTION CODEBOOK

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/718,653

(22) PCT Filed: Feb. 2, 2022
(86) PCT No.: PCT/CN2022/075309

§ 371 Date: Jun. 11, 2024

(51) Int. Cl. H04B 7/06; H04B 7/0456; H04B 17/318

(52) U.S. Cl. CPC H04B 7/0626; H04B 7/0478; H04B 17/328

(57) ABSTRACT

Certain aspects of the present disclosure provide techniques for precoding with a time division multiplexed resource selection codebook. A method that may be performed by a user equipment includes receiving a channel state information (CSI) report setting that indicates to the UE to report precoding matrix indicator (PMI) feedback determined based on a codebook corresponding to a combination of time-division multiplexed CSI reference signal (CSI-RS) or synchronization signal block (SSB) resources. The method may also include reporting CSI with the PMI feedback associated with one or more resources in the time-division multiplexed CSI-RS or SSB resources.

### INTRODUCTION

Aspects of the present disclosure relate to wireless communications, and more particularly, to techniques for codebook-based precoding.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include codebook-based precoding for time division multiplexed, beamformed reference signals.

Certain aspects of the subject matter described in this disclosure can be implemented in a method for wireless communication by a user equipment (UE). The method generally includes receiving a channel state information (CSI) report setting indicating to the UE to report precoding matrix indicator (PMI) feedback determined based on a codebook corresponding to a combination of time-division multiplexed CSI reference signal (CSI-RS) or synchronization signal block (SSB) resources; and reporting CSI with the PMI feedback associated with one or more resources in the time-division multiplexed CSI-RS or SSB resources.

Certain aspects of the subject matter described in this disclosure can be implemented in a method for wireless communication by a network entity. The method generally includes sending a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources; sending one or more signals associated with the time-division multiplexed CSI-RS or SSB resources; and obtaining CSI with the PMI feedback associated with at least one of the one or more signals.

Certain aspects of the subject matter described in this disclosure can be implemented in an apparatus for wireless communication. The apparatus generally includes a memory and a processor coupled to the memory. The processor is configured to receive a channel state information (CSI) report setting indicating to report precoding matrix indicator (PMI) feedback determined based on a codebook corresponding to a combination of time-division multiplexed CSI reference signal (CSI-RS) or synchronization signal block (SSB) resources, and report CSI with the PMI feedback associated with one or more resources in the time-division multiplexed CSI-RS or SSB resources.

Certain aspects of the subject matter described in this disclosure can be implemented in an apparatus for wireless communication. The apparatus generally includes a memory and a processor coupled to the memory. The processor is configured to send a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources, send one or more signals associated with the time-division multiplexed CSI-RS or SSB resources, and obtain CSI with the PMI feedback associated with at least one of the one or more signals.

Certain aspects of the subject matter described in this disclosure can be implemented in an apparatus for wireless communication. The apparatus generally includes means for receiving a channel state information (CSI) report setting indicating to report precoding matrix indicator (PMI) feedback determined based on a codebook corresponding to a combination of time-division multiplexed CSI reference signal (CSI-RS) or synchronization signal block (SSB) resources; and means for reporting CSI with the PMI feedback associated with one or more resources in the time-division multiplexed CSI-RS or SSB resources.

Certain aspects of the subject matter described in this disclosure can be implemented in an apparatus for wireless communication. The apparatus generally includes means for sending a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources; means for sending one or more signals associated with the time-division multiplexed CSI-RS or SSB resources; and means for obtaining CSI with the PMI feedback associated with at least one of the one or more signals.

Certain aspects of the subject matter described in this disclosure can be implemented in a computer-readable medium. The computer-readable medium has instructions stored thereon, that when executed by an apparatus, cause the apparatus to perform operations including receiving a channel state information (CSI) report setting indicating to report precoding matrix indicator (PMI) feedback determined based on a codebook corresponding to a combination of time-division multiplexed CSI reference signal (CSI-RS) or synchronization signal block (SSB) resources; and reporting CSI with the PMI feedback associated with one or more resources in the time-division multiplexed CSI-RS or SSB resources.

Certain aspects of the subject matter described in this disclosure can be implemented in a computer-readable medium. The computer-readable medium has instructions stored thereon, that when executed by an apparatus, cause the apparatus to perform operations including sending a channel state information (CSI) report setting that indicates to a user equipment (UE) to report precoding matrix indicator (PMI) feedback based on a codebook corresponding to a combination of time-division multiplexed channel state information reference signal (CSI-RS) or synchronization signal block (SSB) resources; sending one or more signals associated with the time-division multiplexed CSI-RS or SSB resources; and obtaining CSI with the PMI feedback associated with at least one of the one or more signals.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 is a diagram illustrating example operations where beam management may be performed.

FIGS. 5A and 5B illustrate an example of hierarchical beam refinement operations between a base station (e.g., a gNB) and a user equipment.

FIG. 6 is a diagram illustrating an example operation of estimating or predicting properties associated with narrow beams using wide beams.

FIG. 7 is a diagram illustrating an example of reporting properties associated with a subset of beams.

FIG. 8 is a diagram of an example wireless communication network 800 using a time division multiplexed resource selection codebook.

FIG. 9 is a signaling flow illustrating an example of reporting codebook-based precoding feedback for time division multiplexed resources.

+

FIGS. 10A, 10B, and 10C are diagrams illustrating example linear combination constraints.

FIG. 11 is a diagram illustrating an example of a power constraint.

FIGS. 12A-C are diagrams illustrating example time division multiplexed reference signal resource patterns.

FIG. 13 is a flow diagram illustrating example operations for wireless communication, for example, by a user equipment.

FIG. 14 is a flow diagram illustrating example operations for wireless communication, for example, by a network entity.

FIG. 15 is a diagram illustrating an example disaggregated base station architecture.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for time division multiplexed resource selection codebook for codebook-based precoding.

A wireless communication network may communicate with a user equipment (UE) via codebook-based precoding. For example, a codebook may define a set of precoding matrices that can be used at the network for transforming downlink data streams to a UE across multiple antennas. The network may indicate to the UE the precoding matrices used for precoding at the transmitter via the codebook. The network may transmit a non-precoded reference signal and precoded data to the UE. The UE may derive the channel carrying the precoded data for demodulation based on measurements of the non-precoded reference signals and the precoder associated with the codebook. The UE may provide precoding feedback to indicate to the network the precoder derived at the UE. In certain cases of codebook-based precoding, the network may transmit beamformed reference signals (e.g., channel state information reference signals (CSI-RSs)) to the UE, where the codebook (e.g., a Type II port selection codebook) may include precoding matrices based on linear combinations of different CSI-RS ports (e.g., CSI-RS beams), which are frequency division multiplexed or code division multiplexed.

In some cases, the network may perform beamforming of the CSI-RS transmissions to the UE, and in such cases, the codebook may be referred to as a Type II port selection codebook.

In some cases, beams (e.g., beamformed transmissions of CSI-RSs or synchronization signal blocks (SSBs)) are swept over time due to analog beamforming being used for certain frequency bands, such as millimeter wave (mmWave) bands or Frequency Range 2 (FR2). For example, different beam of analog beamformed transmissions may be time division multiplexed in mmWave bands, meaning different beam transmissions occur at different times as opposed to the same time. A codebook that uses linear combinations of CSI-RS ports for beam prediction (e.g., the Type II port selection codebook) may not be suitable for or compatible with time division multiplexed resources in mmWave bands or FR2, where the beam predictions may enable the UE to determine spatial filter(s) for receiving beamformed signals.

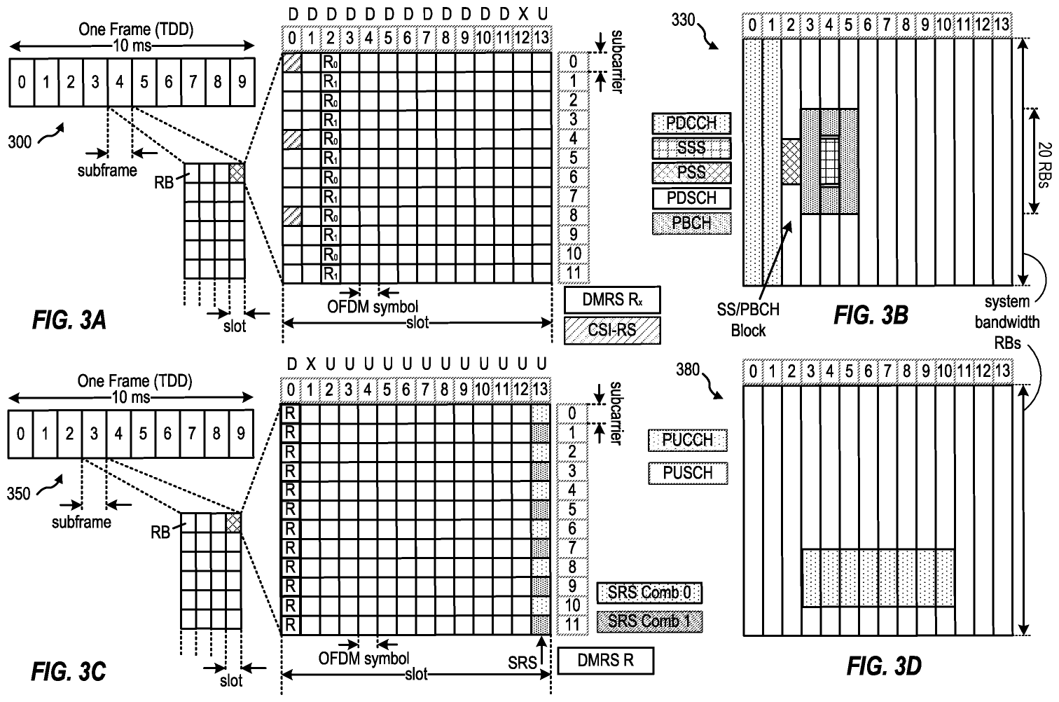

Aspects of the present disclosure provide apparatus and methods for codebook-based precoding feedback for time division multiplexed CSI-RS/SSB resources. For example, the network may configure the UE with a CSI-RS/SSB resource selection codebook for beam property prediction of time division multiplexed CSI-RS/SSB resources. The UE may report CSI based on the codebook for time division multiplexed CSI-RS/SSB resources. The codebook may include a precoding matrix that corresponds to a linear combination of amplitudes and/or co-phasing phase shifts of time division multiplexed CSI-RS/SSB resources. For example, the linear combination may include a summation of amplitude and phase shift products for a subset of the CSI-RS/SSB resources, where each of the amplitudes and phase shifts is associated with a CSI-RS/SSB resource. The codebook may provide certain properties associated with the linear combination of the CSI-RS/SSB resources. As used herein, a CSI-RS/SSB resource may correspond to a frequency domain resource, a time domain resource, a spatial resource, a code resource (e.g., for code-division multiplexing), and/or a time-frequency resource for a CSI-RS or an SSB, for example, as described herein with respect to FIGS. 3A-3D.

The CSI-RS/SSB resource selection codebook described herein may facilitate precoding determination and/or feedback for time division multiplexed resources, such as wireless communications in mmWave bands or FR2. The CSI-RS/SSB resource selection codebook described herein may enable desirable wireless communication performance in mmWave bands, such as reduced latencies, higher data rates, and/or spectral efficiencies, for example, due to the precoding feedback for the time division multiplexed resources, which may facilitate accurate channel estimations at the transmitter and/or receiver.

### Introduction to Wireless Communication Networks

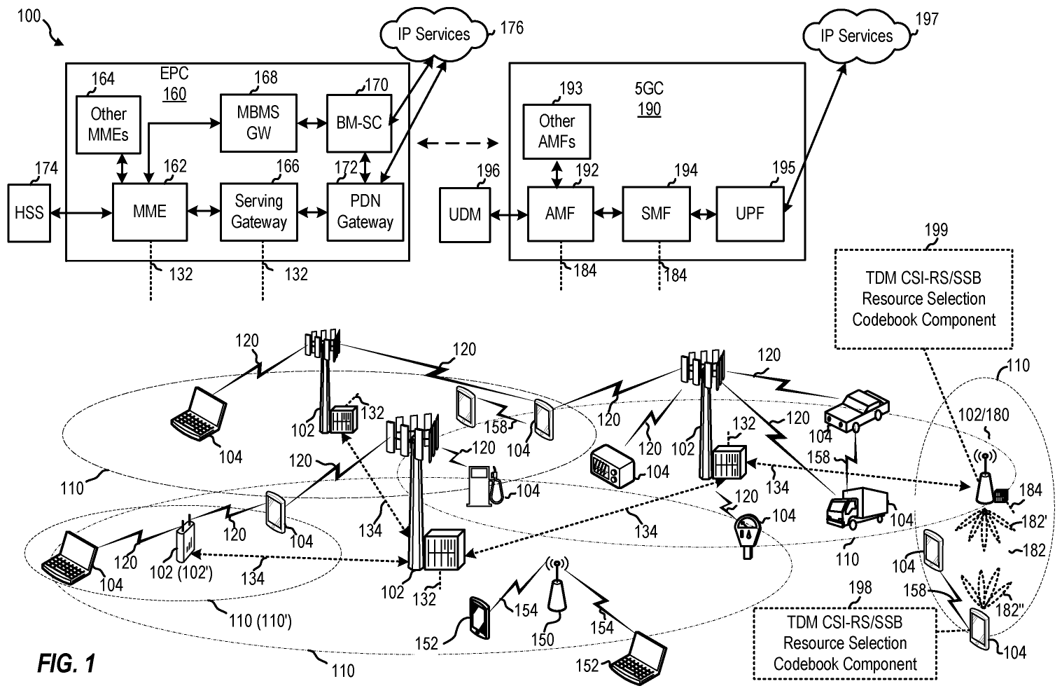

FIG. 1 depicts an example of a wireless communication network 100, in which aspects described herein may be implemented.

Generally, wireless communication network 100 includes base stations (BSs) 102, user equipment (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit beams 182′. UE 104 may receive the beamformed signal from the base station 180 in one or more receive beams 182″. UE 104 may also transmit a beamformed signal to the base station 180 in one or more transmit beams 182″. Base station 180 may also receive the beamformed signal from UE 104 in one or more receive beams 182′. Base station 180 and UE 104 may then perform beam training to determine the best receive and transmit beams for each of base station 180 and UE 104. Notably, the transmit and receive beams for base station 180 may or may not be the same. Similarly, the transmit and receive beams for UE 104 may or may not be the same.

The term “beam” may be used in the present disclosure in various contexts. Beam may be used to mean a set of gains and/or phases (e.g., pre-coding weights or co-phasing weights (phase shifts)) applied to antenna elements in the UE and/or BS for transmission or reception. The term “beam” may also refer to an antenna or radiation pattern of a signal transmitted while applying the gains and/or phases to the antenna elements. Other references to beam may include one or more properties or parameters associated with the antenna (radiation) pattern, such as angle of arrival (AoA), angle of departure (AoD), gain, phase, directivity, beam width, beam direction (with respect to a plane of reference) in terms of azimuth and elevation, peak-to-side-lobe ratio, or an antenna port associated with the antenna (radiation) pattern. The term “beam” may also refer to an associated number and/or configuration of antenna elements (e.g., a uniform linear array, a uniform rectangular array, or other uniform array).

Wireless communication network 100 includes a time division multiplexed (TDM) CSI-RS/SSB resource selection codebook component 199, which may be configured to configure a UE with the TDM CSI-RS/SSB resource selection codebook and receive corresponding precoding feedback for the codebook. Wireless communication network 100 further includes a TDM CSI-RS/SSB resource selection codebook component 198, which may be used configured to provide precoding feedback based on a TDM CSI-RS/SSB resource selection codebook configured by the network.

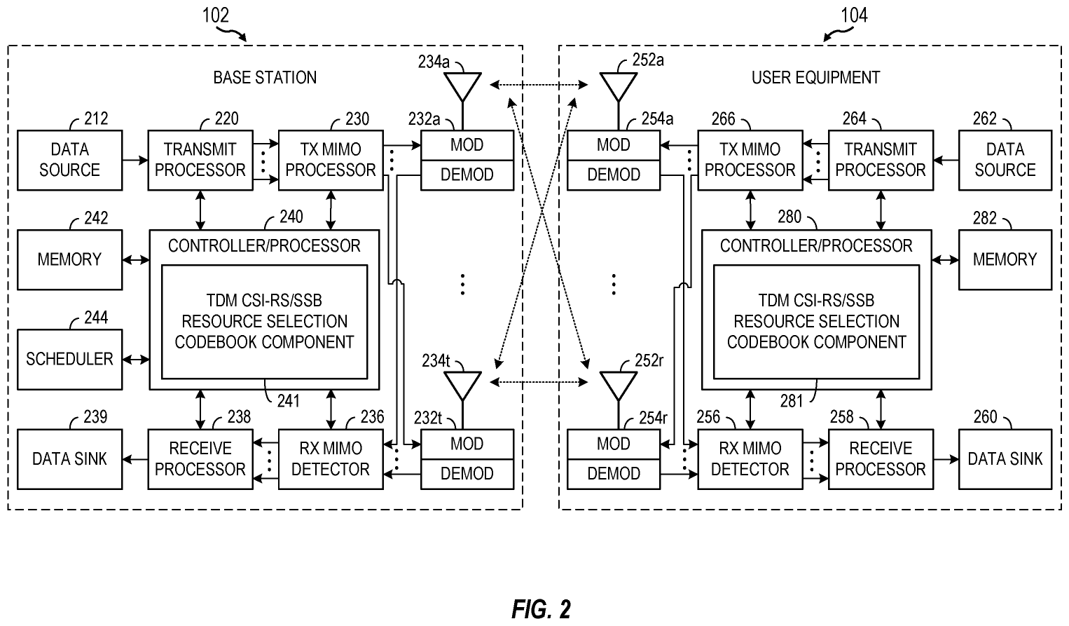

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes a TDM CSI-RS/SSB resource selection codebook component 241, which may be representative of the TDM CSI-RS/SSB resource selection codebook component 199 of FIG. 1. Notably, while depicted as an aspect of controller/processor 240, the TDM CSI-RS/SSB resource selection codebook component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes a TDM CSI-RS/SSB resource selection codebook component 281, which may be representative of the TDM CSI-RS/SSB resource selection codebook component 198 of FIG. 1. Notably, while depicted as an aspect of controller/processor 280, the TDM CSI-RS/SSB resource selection codebook component 281 may be implemented additionally or alternatively in various other aspects of UE 104 in other implementations.

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Communications using mmWave/near mm Wave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, analog beamforming may be used in mmWave bands, such that time division multiplexed resources sweep through different beams over time.

### Example Beam Management

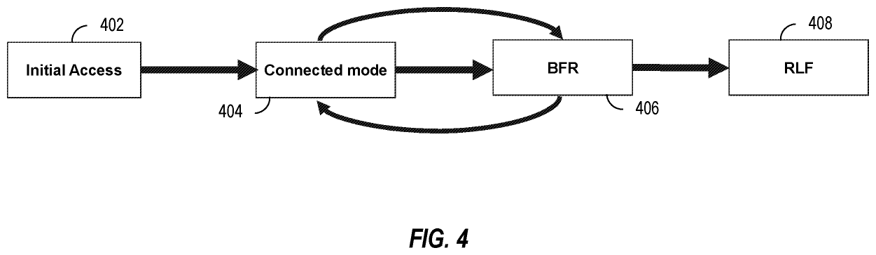

In wireless communications, various procedures may be performed for beam management. FIG. 4 is a diagram illustrating example operations where beam management may be performed. In initial access 402, the network may sweep through several beams, for example, via synchronization signal blocks (SSBs), as further described herein with respect to FIG. 3B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS).

In connected mode 404, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 406, which may allow a UE to return to connected mode 404 without performing a radio link failure procedure 408. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 408 to recover from the radio link failure, such as a RACH procedure.

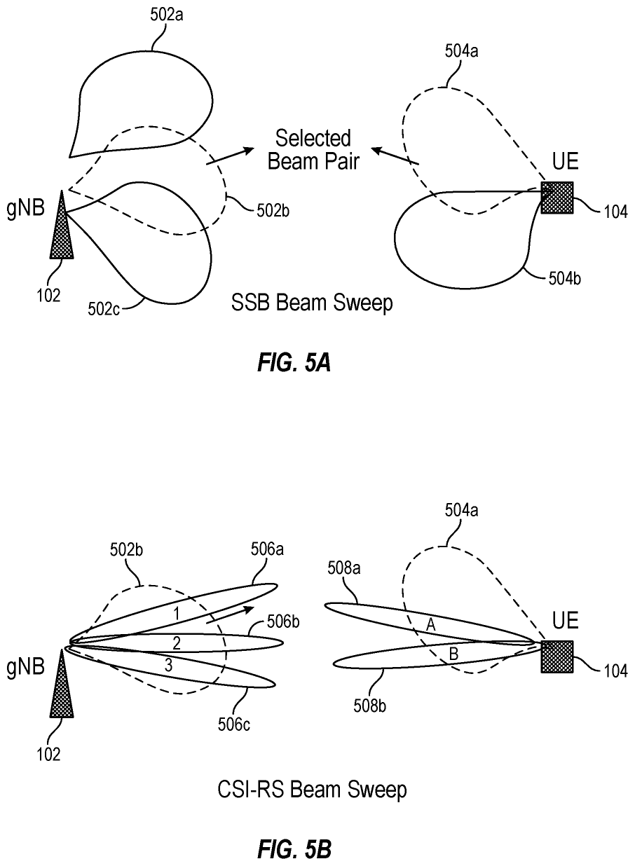

FIGS. 5A and 5B illustrate an example of hierarchical beam refinement operations between a BS 102 and a UE 104. Referring to FIG. 5A, the BS 102 may beam sweep through certain reference signals (e.g., SSBs), for example, with transmit beams 502a-c, and the UE may select a receive beam 504a associated with a particular SSB among the receive beams 504a, 504b. For example, the SSB with the best channel properties measured at the UE 104 may be selected.

Referring to FIG. 5B, the BS 102 may refine the beam selection by sweeping through narrower beams 506a-c (e.g., CSI-RSs) within the selected SSB with the transmit beam 502b. The UE may report channel properties associated with a subset of the narrower beams (e.g., less than all of the narrower beams), for example, beams 508a, 508b at the UE 104, which may correspond to the beams 506b, 506c at the BS 102. The UE 104 may refine the receive beam selection by adjusting spatial reception parameters.

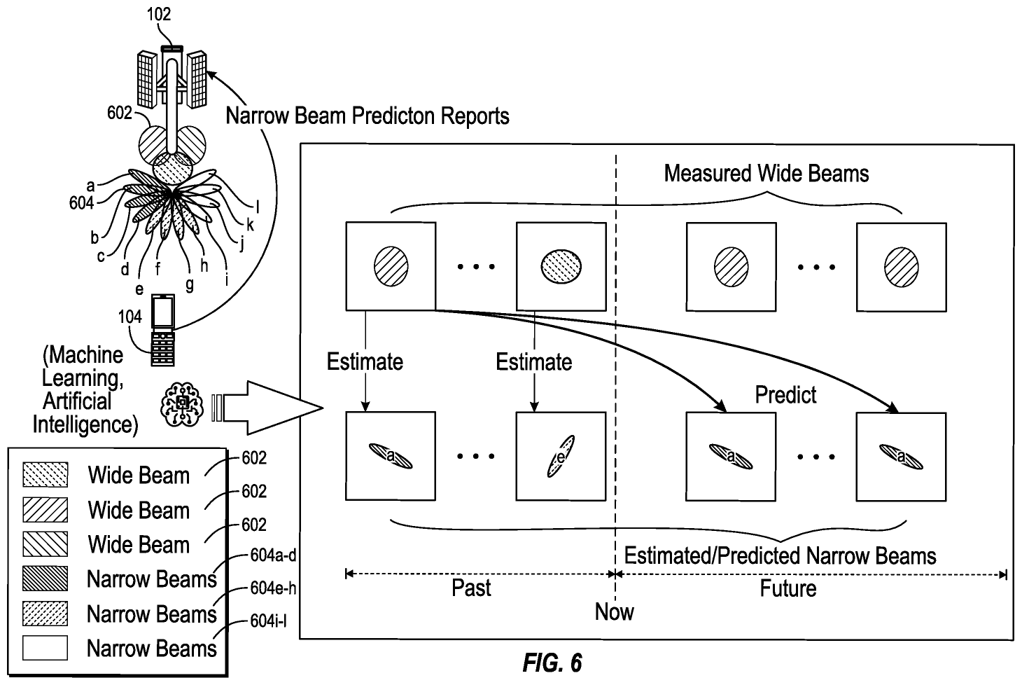

In certain aspects, a UE may estimate or predict properties associated with narrow beams (e.g., narrow beams 506a-c in the wide beam as depicted in FIG. 5B) using measurements of a wide beam (e.g., wide beam 502b). FIG. 6 is a diagram illustrating an example operation of estimating or predicting properties associated with narrow beams using wide beams. In this example, the BS 102 may transmit three wide beams 602 and twelve narrow beams 604, where each of the wide beams 602 is associated with four of the narrow beams. The UE 104 may measure certain properties associated with the wide beams 602, and the UE 104 may estimate properties or predict future properties associated with one or more of the narrow beams 604 based on the measurements of the wide beams 602. In certain aspects, the UE 104 may use machine learning, regression, or artificial intelligence to determine the properties associated with the narrow beams 604 based on the measurements of the wide beams 602. The properties may include, for example, a channel quality indicator, a signal-to-noise ratio (SNR), a signal-to-interference plus noise ratio (SINR), a signal-to-noise plus distortion ratio (SNDR), a received signal strength indicator (RSSI), a reference signal received power (RSRP), a reference signal received quality (RSRQ), and/or a block error rate (BLER), for example.

Those of skill in the art will understand that the wide beam-based estimation/prediction of narrow beam properties illustrated in FIG. 6 is an example. Measurements associated with one or more beams may be used to predict or estimate properties associated with other beams, for example, regardless of the beam shapes or whether some beams are arranged in the radiation pattern of one or more other beams.

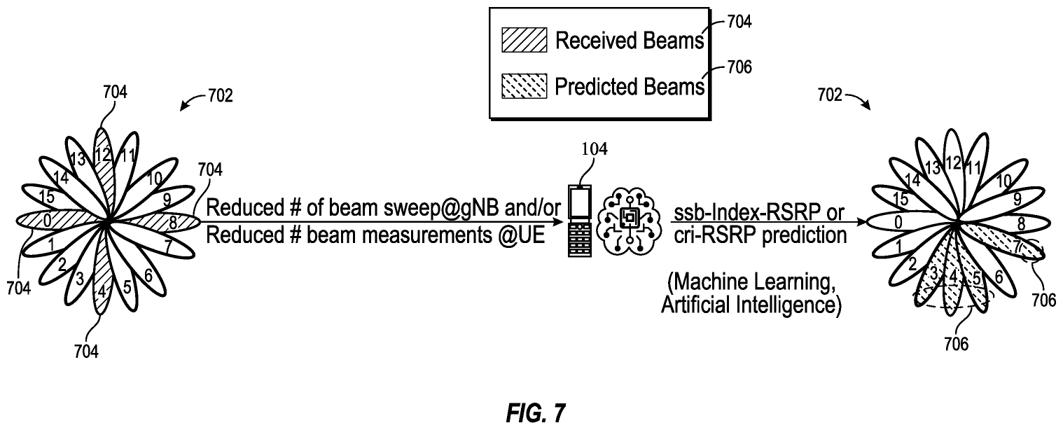

In certain aspects, the UE may report properties associated with a subset of (e.g., less than all) beams, for example, using measurements from one or more beams in another subset of beams. FIG. 7 is a diagram illustrating an example of reporting properties associated with a subset of beams. In this example, the BS (not shown) may transmit reference signals using the beams 702. In some cases, the BS may reduce the number of transmissions for the beams. For example, the BS may transmit reference signals using a first subset of beams 704 (e.g., the beams 0, 4, 8, 12) without the other beams. In certain cases, the BS may initially or occasionally (e.g., periodically) transmit reference signals with the first subset of beams 704. In other cases, the UE may reduce the number of measurements taken for the beams. For example, the BS may transmit reference signals using the beams 702, and the UE 104 may measure properties associated with the first subset of beams 704. Regardless of whether the BS reduces the beam transmission or the UE reduces the beam measurements, the UE 104 may report properties associated with a second subset of beams 706 based on the measurements of the first subset of beams 704. The UE 104 may be configured with or determine spatial relationship(s) (e.g., angle of departures, zenith angle of departures, etc.) between the first subset of beams 704 and the second subset of beams 706, and the UE 104 may use the spatial relationships to determine the properties associated with the second subset of beams 706 based on the measurements of the first subset of beams 704. In certain cases, the UE 104 may use machine learning and/or artificial intelligence to determine the properties associated with the second subset of beams 706 based on the measurements of the first subset of beams 704.

In certain aspects, the network may communicate with the UE via codebook-based precoding. To demodulate, the UE estimates a non-precoded channel based on a reference signal (e.g., CSI-RS or SSB) and derives the precoded channel based on a transmit precoder, which may be signaled by the network or determined at the UE based on codebook. For example, the network may indicate to the UE a transmit precoder used for downlink transmissions to perform demodulation at the UE. Such an indication may be a precoding matrix indicator (PMI) associated with a particular codebook, which may provide one or more precoding matrices for channel estimation, for example. The UE may report certain channel state information (CSI) using the codebook to determine one or more precoding matrices for demodulation. A CSI report may include a channel quality indicator (CQI), a precoding matrix indicator (PMI), a CSI-RS resource indicator (CRI), and a rank indicator (RI). The structure of the PMI may vary based on the codebook.

As an example, a codebook may include a precoding matrix that maps each layer (e.g., data stream) to a particular antenna port. In some cases, a codebook may include a precoding matrix that provides a linear combination of multiple input layers. In certain cases, the codebook may include a set of precoding matrices, where the UE may select one of the precoding matrices for channel estimation. The codebook may indicate how a data stream is precoded at the transmitter, which may enable the receiver to demodulate the received data stream. Example codebooks include a Type I single panel codebook, Type I multi-panel codebook, Type II single panel codebook, Type II multi-panel codebook, Type II port selection codebook, etc.

For a Type I single panel codebook, the precoding matrix may be determined using a W₁ matrix (e.g., a subest of beams) and a W₂ matrix (e.g., a phase for cross polarization combination and beam selection). For example, the precoding matrix (W) may be determined as follows:

$$W = {W}_{1} {W}_{2} ,$$

$$where$$

$${W}_{1} = [ \begin{matrix}B & 0 \\ 0 & B\end{matrix} ] .$$

For a Type I multi-panel codebook, compared to type I single panel codebook, the precoding matrix may also include a phase for cross panel combination. The network may have a plurality of transmit beams. The UE can indicate to the network an index of a preferred beam, or beams, of the candidate beams. For example, the UE may provide feedback on the precoding vector w for the/-th layer:

$${w}_{l} = ( \begin{matrix}{b}_{+ 45 pol} \\ φ \cdot {b}_{- 45 pol}\end{matrix} )$$

where b represents the oversampled beam (e.g., discrete Fourier transform (DFT) beam), for both polarizations, and φ is the co-phasing.

For a Type II codebook (which may be designed for single panel), the precoding matrix may be a linear combination of beams. The codebook may use a subset of orthogonal beams for linear combination. The precoding matrix may include a linear combination of amplitudes and phases (e.g., co-phasing phase shifts) of the beams. The preferred precoder for a layer can be a combination of beams and associated quantized coefficients. In certain cases, the UE may indicate to the network the beams and coefficients selected for the precoder and channel estimation. In some cases, the network may perform beamforming of the CSI-RS transmissions to the UE, and in such cases, the codebook may be referred to as a Type II port selection codebook.

### Aspects Related to Time Division Multiplexed CSI-RS SSB Resource Selection Codebook

Aspects of the present disclosure provide apparatus and methods for codebook-based precoding feedback, for example, for time division multiplexed, beamformed CSI-RS/SSB resources. For example, the network may configure the UE with a CSI report setting that identifies a codebook with a precoding matrix for a linear combination of time division multiplexed CSI-RS/SSB resources. The codebook may use a subset of (e.g., less than all) the CSI-RS/SSB resources, which are selected for the precoding matrix and/or precoding feedback (e.g., a linear combination of amplitudes and phases (e.g., co-phasing phase shifts) of the beams). The codebook may use quantized linear combination coefficients for the CSI-RS/SSB resources. In certain aspects, the codebook may provide certain properties (e.g., Layer 1-RSRP and/or Layer 1-SINR) associated with the linear combination of the CSI-RS/SSB resources.

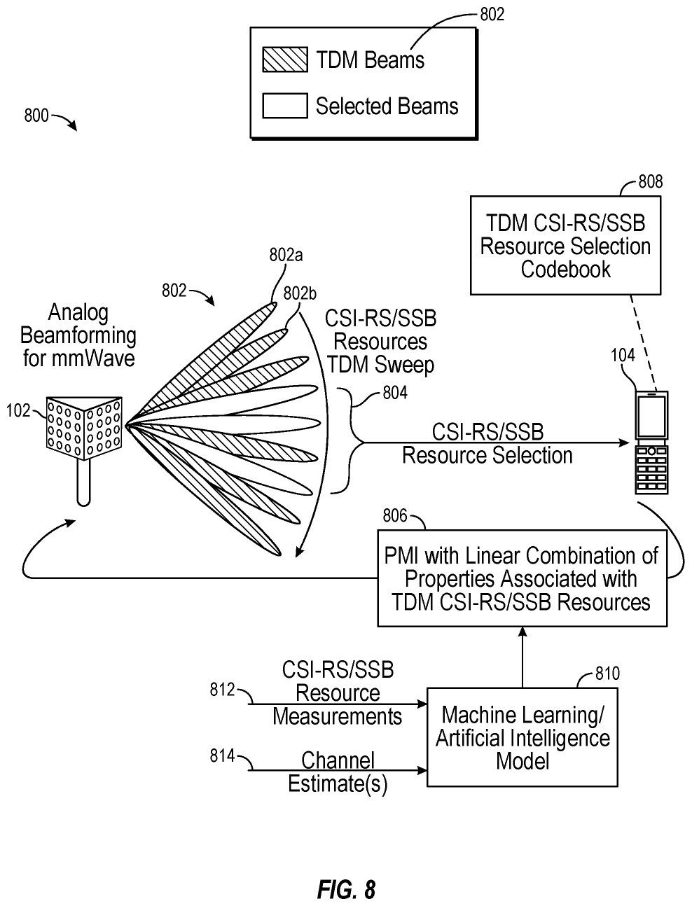

FIG. 8 is a diagram of an example wireless communication network 800 using a time division multiplexed resource selection codebook 808. In this example, the BS 102 may transmit analog beamformed reference signals using CSI-RS/SSB resources, for example, in the mmWave bands. Each of the beams 802 may represent different CSI-RS/SSB resources used for sweeping through the beams 802 over time. For example, the

BS 102 may transmit a reference signal using a first beam 802a in a different transmission occasion (e.g., in different time resources) than another reference signal using a second beam 802b, and so on for the remaining beams.

The UE 104 may receive the reference signals corresponding to all of the beams 802 or a subset of the beams 802. The UE 104 may determine PMI feedback 806 associated with a subset of the CSI-RS/SSB resources 804 selected for the precoder and/or precoding feedback based on the codebook 808. The PMI feedback may include a linear combination of the subset of CSI-RS/SSB resources, where the linear combination may include a wideband-specific linear combination (e.g., a wideband report), a subband-specific linear combination (e.g., a subband report), and/or a frequency domain (FD) compression of a subband-specific linear combination. A wideband report may include a PMI report for an entire bandwidth of the CSI-RS/SSB resources configured for the PMI feedback or an entire bandwidth of a subset of the CSI-RS/SSB resources. A subband report may include a PMI report for a portion (e.g., a subband) of the bandwidth of the CSI-RS/SSB resources configured for the PMI feedback or a portion of the bandwidth of a subset of the CSI-RS/SSB resources. For example, the PMI feedback may be indicative of a precoding matrix that is a linear combination of amplitudes and co-phasing of the subset of CSI-RS/SSB resources, which are time division multiplexed.

In certain cases, the UE 104 may train a machine learning or an artificial intelligence model 810 to determine the PMI feedback (e.g., precoding matrix components defined by the codebook 808) based on measurements (e.g., the RSRP) 812 of the CSI-RS/SSB resources 802 and/or channel estimate(s) 814 based on the CSI-RS/SSB resources. For example, the UE 104 may develop correlations or relationships between measurements of the CSI-RS/SSB resources 802 and the PMI feedback 806. The UE 104 may use the measurements 812 and/or channel estimates 814 as training data for the machine learning or artificial intelligence model 810, which may also use the measurements 812 and/or the channel estimates 814 as input to determine the PMI feedback 806.

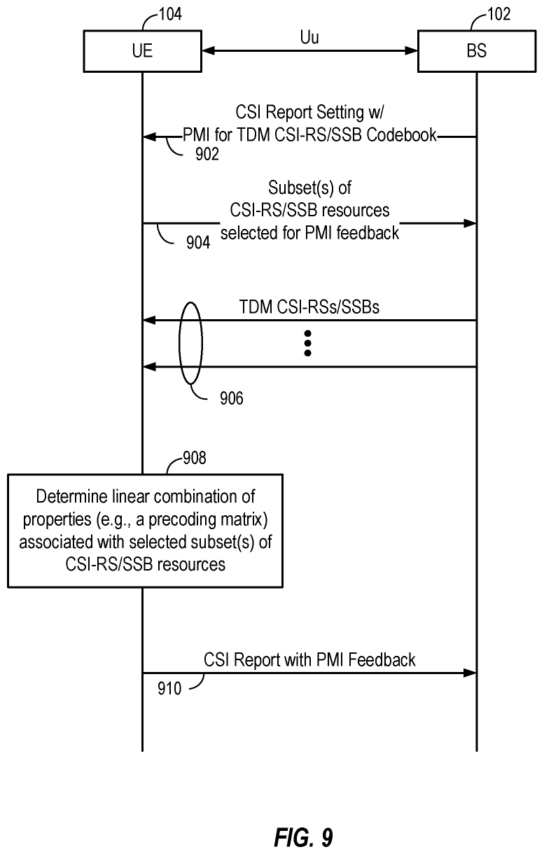

FIG. 9 is a signaling flow illustrating an example of reporting codebook-based precoding feedback for time division multiplexed CSI-RS/SSB resources. At activity 902, the UE 104 may receive, from the BS 102, a CSI report setting that indicates to the UE to report PMI feedback using a time division multiplexed CSI/RS/SSB resource selection codebook as described herein. For example, the codebook may include a precoding matrix that is a linear combination of time-division multiplexed CSI-RS or SSB resources. The UE 104 may receive the CSI report setting via control signaling, such as radio resource control (RRC) signaling, where the CSI report setting may be represented as a CSI-ReportConfig information element an an RRC message.

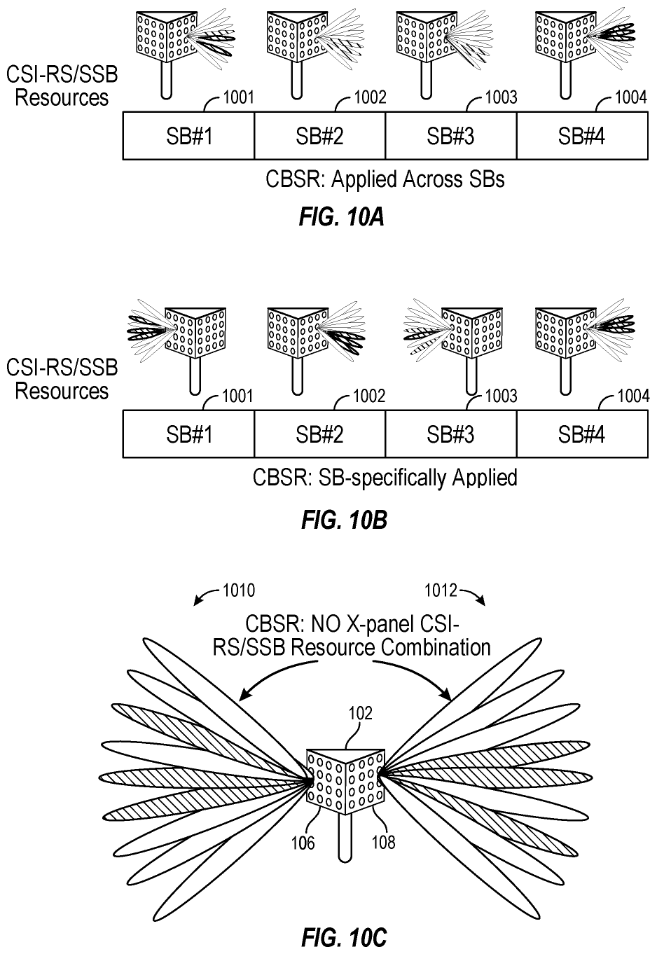

The UE 104 may receive other settings via control signaling, such as RRC signaling, downlink control information (DCI), medium access control (MAC) signaling, and/or system information. For example, the UE 104 may receive one or more resource settings (e.g., CSI-ResourceConfig in RRC signaling) identifying the CSI-RS or SSB resources associated with the CSI report setting. In some cases, the UE may receive signaling that indicates the number of resources in a subset of the CSI-RS/SSB resources and/or the number of subsets. In certain cases, the UE 104 may receive constraints related to linear combinations in the codebook, for example, as further described herein with respect to FIGS. 10A, 10B, and 10C. For example, the UE 104 may receive signaling that indicates one or more constraints for the codebook on whether one or more linear combinations are applied in the PMI feedback to one or more of the CSI-RS or SSB resources. The UE 104 may receive signaling that indicates one or more constraints for the codebook on amplitudes of linear combination coefficients associated with one or more of the CSI-RS or SSB resources selected for the PMI feedback. In certain cases, the UE 104 may receive signaling indicating one or more machine learning models for processing the PMI feedback, as further described herein.

At activity 904, the UE 104 may transmit, to the BS 102, an indication of one or more subsets of the CSI-RS/SSB resources selected for PMI feedback. The UE 104 may select the resources in the subsets of CSI-RS/SSB resources configured for the PMI feedback and provide the BS 102 with an indication of the selected resources. The UE 104 may provide an indication of components within a precoding matrix as the subsets of CSI-RS or SSB resources, where different components within the precoding matrix may identify different CSI-RS or SSB resources. The UE 104 may provide resource indicators for resources in the subsets of the CSI-RS or SSB resources selected for PMI feedback.

At activity 906, the UE 104 may receive, from the BS 102, one or more of the time division multiplexed reference signals associated with the CSI-RS/SSB resources. For example, the UE 104 may receive a subset of reference signals associated with the CSI-RS/SSB resources. In certain cases, the BS 102 may only transmit a subset of reference signals associated with the CSI-RS/SSB resources, for example, as described herein with respect to FIG. 7. Alternatively, or additionally, the UE 104 may only measure the subset of reference signals associated with the CSI-RS/SSB resources, for example, as described herein with respect to FIG. 7.

At activity 908, the UE 104 may process measurements of the reference signals associated with the CSI-RS/SSB resources to determine PMI feedback. For PMI feedback, the UE 104 may determine linear combination(s) of properties (e.g., quantized combination coefficients for amplitudes and/or co-phasing phase shifts) associated with the selected subset(s) of CSI-RS/SSB resources. In certain cases, the UE 104 may use machine learning, artificial intelligence, and/or regression analysis to determine quantized combination coefficients, for example, as described herein with respect to FIGS. 6 and 7.

At activity 910, the UE 104 may transmit, to the BS 102, a CSI report including the determined PMI feedback.

In certain aspects, the codebook may have linear combination constraint(s) on certain subsets of CSI-RS/SSB resources. The UE may be configured with a codebook subset constraint regarding whether linear combinations can be applied to two or more subset of the configured CSI-RS/SSB resources. As an example, a constraint may provide that only certain CSI-RS resource can be linearly combined with each other. For a subband-specific precoding report, a constraint may apply to specific subband(s) or apply to all subbands. For certain aspects, the constraints may be applied in cases where different subsets of CSI-RSs are transmitted from different (non-coherent) panels. In certain aspects, if CSI-RS resources and SSB resources are configured for precoding feedback of a CSI report setting, the CSI-RS resources may only be linearly combined with the CSI-RS resources, and SSB resources may only be linearly combined with the SSB resources. In some aspects, the constraints may be related to spatial relationships among the CSI-RS/SSB resources. For example, the codebook may have a constraint where CSI-RS/SSB resources from different panels (e.g., transmission-reception points or remote radio heads) may not be linearly combined with each other. A codebook subset constraint can also refer to a codebook subset restriction (CBSR).

FIGS. 10A, 10B, and 10C are diagrams illustrating example linear combination constraints. Referring to FIGS. 10A and 10B, suppose the UE is configured with eight CSI-RS resources (e.g., CSI-RS resources #1-#8) and configured to select three of the CSI-RS resources for linear combination. The UE may also be configured to report subband-specific linear combinations for subbands 1001-1004 (SB #1-#4). The codebook may have constraints where only CSI-RS resource #1-#4 can be linearly combined with each other, and where only CSI-RS resource #5-8 can be linearly combined with each other.

Referring to FIG. 10A, if the constraint(s) are applied to all of the subbands, the UE may report a subband specific linear combination using CSI-RS #1-#3 for subband 1001 (SB #1) and another subband specific linear combination using CSI-RS #2-#4 for subband 1002 (SB #2).

Referring to FIG. 10B, if the constraint(s) are applied to specific subbands (e.g., subband 1001 and subband 1003), the UE may report a linear combinations using CSI-RS #1-#3 for subband 1001 (SB #1) and another linear combination using CSI-RS #1, #3, and #5 for subband 1002 (SB #2), which may not use the constraints CSI-RS resource #1-#4 and CSI-RS resource #5-#7.

Referring to FIG. 10C, the BS 102 may have a first panel 1006 and a second panel 1008, where a first set of CSI-RS/SSB resources 1010 may be transmitted from the first panel 1006, and a second set of CSI-RS/SSB resources 1012 may be transmitted from the second panel 1008. A constraint may provide that any of the first set of CSI-RS/SSB resources 1010 may not be linearly combined with any of the second set of CSI-RS/SSB resources 1012.

In certain aspects, the codebook may have amplitude (power) constraints on feedback coefficients for certain subsets of CSI-RS/SSB resources. The UE may be configured with codebook subset restrictions regarding amplitude restrictions on the feedback coefficients. For example, the codebook may restrict the total allocated power (after linear combination) for a certain subset of CSI-RS/SSB resources to be less than, equal to, or greater than a threshold. The threshold may be determined based on a ratio between the total number of selected CSI-RS/SSB resources and the number of selected CSI-RS/SSB resources within the subset. The threshold may depend on the different choices of the selected CSI-RS/SSB resources within a subset of the CSI-RS/SSB resources. For certain aspects, the codebook may restrict the average/total coefficient power associated with a certain subset of selected CSI-RS/SSB resources. The power constraints may be applied in cases where different subsets of CSI-RS/SSB resources are transmitted from different (power constraint) panels or antenna-elements. The power constraints may be applied in cases where power loss is not preferred (e.g., where each subset of CSI-RS/SSB resources is expected to have full power transmission).

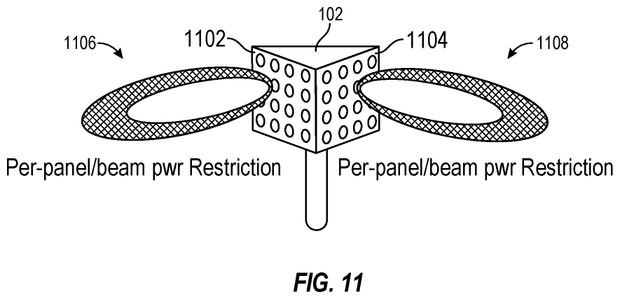

FIG. 11 is a diagram illustrating an example of a power constraint. In this example, the BS 102 may have a first panel 1102 and a second panel 1104, where a first set of CSI-RS/SSB resources 1106 may be transmitted from the first panel 1102, and a second set of CSI-RS/SSB resources 1108 may be transmitted from the second panel 1104

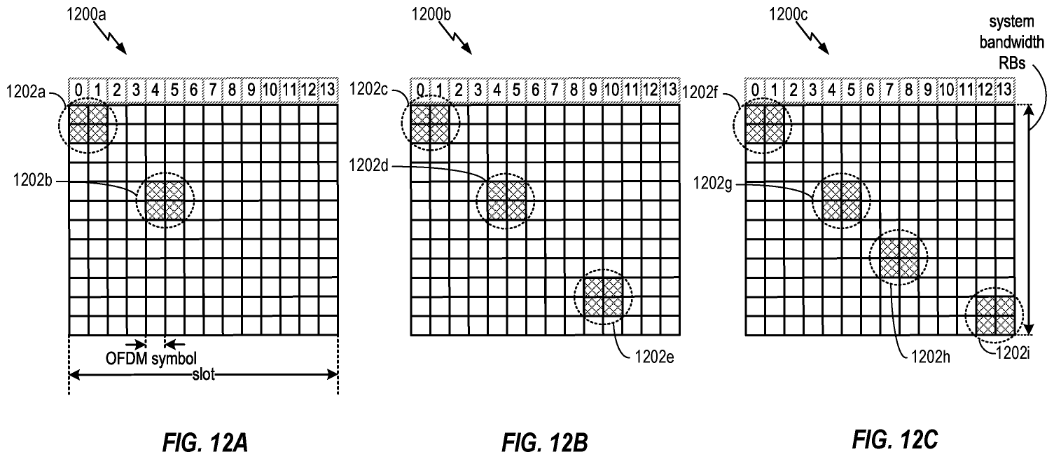

FIGS. 12A, 12B, 12C are diagrams illustrating example time division multiplexed CSI-RS/SSB resource patterns 1200a-c. In this example, the CSI-RS/SSB resource patterns 1200a-c are arranged in an OFDM resource grid, for example, as described herein with respect to FIGS. 3A-3D. The first CSI-RS/SSB resource pattern 1200a may include two groups of CSI-RS/SSB resources 1202a, 1202b in a slot, where each of the groups of CSI-RS/SSB resources 1202a, 1202b may be representative of a time division multiplexed beam, such as one of the beams 802 depicted in FIG. 8. Each of the groups of CSI-RS/SSB resources 1202a, 1202b may be arranged in different time domain resources. For example, the first group of CSI-RS/SSB resources 1202a may be arranged in the first and second symbols of the slot, and the second group of CSI-RS/SSB resources 1202b may be arranged in the fifth and sixth symbols of the slot. The second CSI-RS/SSB resource pattern 1200b may include three groups of CSI-RS/SSB resources 1202c-e, and the third second CSI-RS/SSB resource pattern 1200b may include four groups of CSI-RS/SSB resources 1202f-i.

Those of skill in the art will understand that the CSI-RS/SSB patterns illustrated in FIGS. 12A-C are merely examples. Other time division multiplexed patterns for the CSI-RS/SSB resources may be used in addition to or instead of those illustrated.

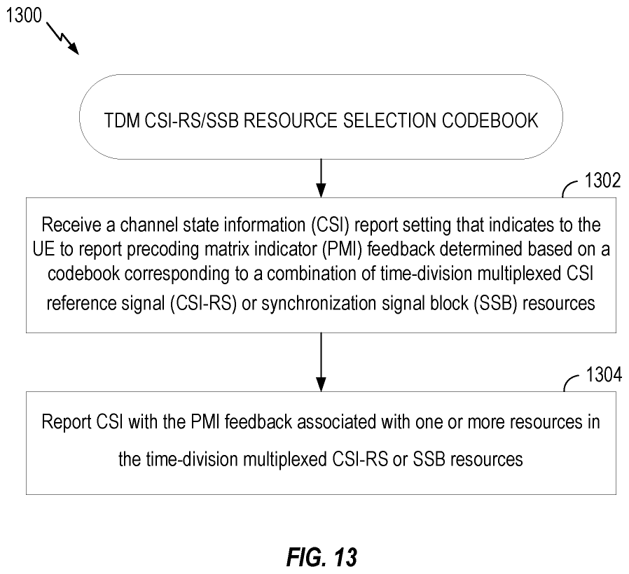

FIG. 13 is a flow diagram illustrating example operations 1300 for wireless communication, in accordance with certain aspects of the present disclosure. The operations 1300 may be performed, for example, by a UE (such as the UE 104 in the wireless communication network 100). The operations 1300 may be implemented as software components that are executed and run on one or more processors (e.g., controller/processor 280 of FIG. 2). Further, the transmission and reception of signals by the UE in operations 1300 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1300 may optionally begin, at block 1302, where the UE may receive a CSI report setting (e.g., the CSI report setting described herein with respect to FIG. 9) that indicates to the UE to report PMI feedback determined based on a codebook corresponding to a combination of time-division multiplexed CSI-RS or SSB resources. For example, the UE may receive, from a network entity (e.g., the BS 102), signaling (e.g., radio resource control signaling) that provides the CSI report setting. In certain aspects, the UE may receive one or more resource settings identifying the CSI-RS or SSB resources associated with the CSI report setting. As used herein, CSI-RS or SSB resources may refer to one or more CSI-RS resources and/or one or more SSB resources.

At block 1304, the UE may report CSI with the PMI feedback associated with one or more resources in the time-division multiplexed CSI-RS or SSB resources. For example, the UE may transmit the CSI with the PMI feedback to the network entity. The PMI feedback may provide quantized combination coefficients (e.g., coefficients for amplitudes and/or co-phasing phase shifts) of a precoding matrix for a linear combination of a subset of the CSI-RS/SSB resources.

The PMI feedback, as determined according to the codebook, may include feedback (e.g., coefficients for a precoding matrix) associated with one or more subsets of the CSI-RS or SSB resources selected for the PMI feedback. The PMI feedback may include quantized combination coefficients of the CSI-RS or SSB resources. In certain aspects, the PMI feedback may include a combined RSRP or a combined SINR for the combination of the CSI-RS or SSB resources or a subset of the CSI-RS or SSB resources.

In certain aspects, the PMI feedback may be based on past measurements of the CSI-RS/SSB resources or future predictions of beams associated with the CSI-RS/SSB resources. For example, the quantized combination coefficients may be indicative of past measurements of the CSI-RS/SSB resources or future predictions of beams associated with the CSI-RS/SSB resources. In some cases, the CSI report setting may be associated with a PMI report based on the past measurements and/or future predicted beams. The CSI report setting may further indicate that the PMI feedback includes one or more past measurements or one or more future predictions based on the CSI-RS or SSB resources.

For certain aspects, the codebook may have a set number of resources in a subset of the CSI-RS/SSB resources and/or a set number of subsets of the CSI-RS/SSB resources for the PMI feedback. For example, the number of CSI-RS/SSB resources within a subset of CSI-RS/SSB resources and/or the number of subsets can be predefined (e.g., defined in 3GPPP standards for 5G NR systems), configured by the network, and/or determined by the UE and recommended to the network. In some cases, the codebook may include a preconfigured first number of resources in each of the one or more subsets, a preconfigured second number of the one or more subsets, or any combination thereof. In certain cases, the UE may receive signaling that indicates a first number of resources in each of the one or more subsets, a second number of the one or more subsets, or any combination thereof. In some cases, the UE may transmit, to a network entity (e.g., the BS 102), an indication of a first number of resources in each of the one or more subsets, a second number of the one or more subsets, or any combination thereof.

The number of CSI-RS/SSB resources in a subset and the number of subsets may be common among layers, specific to a layer, common among ranks, and/or specific to a rank. Such configurations may be predefined, configured by the network, and/or recommended by the UE. A first number of resources in each of the one or more subsets and/or a second number of the one or more subsets is different for different layers associated with the PMI feedback or different for different rank indicators associated with the PMI feedback. The first number of resources in each of the one or more subsets or a second number of the one or more subsets is common for different layers associated with the PMI feedback or common for different rank indicators that are associated with the PMI feedback.

In certain aspects, the PMI feedback may provide a wideband report, a subband report, and/or a FD compression of a subband report. The quantized combination coefficients in the PMI feedback may be based on a wideband-specific linear combination associated with resources in the one or more subsets, a subband-specific linear combination associated with resources in the one or more subsets, a FD compression of a subband-specific linear combination associated with resources in the one or more subsets, or any combination thereof. For example, the quantized linear combination coefficients may be for a wideband-specific report, a subband-specific report, and/or a FD compression of a subband-specific report.

For certain aspects, the UE may provide the network entity with an indication of the CSI-RS/SSB resources selected for the PMI feedback. The UE may provide the indication in the PMI feedback or separate uplink signaling to the network entity. For example, the PMI feedback may indicate the one or more subsets of the CSI-RS or SSB resources selected for the PMI feedback through an indication of components within a matrix (e.g., a precoding matrix) as the one or more subsets of the CSI-RS or SSB resources, where different components within the matrix identify different CSI-RS or SSB resources; resource indicators for resources in the one or more subsets of the CSI-RS or SSB resources; or any combination thereof. The resource indicators may include a CSI-RS resource indicator (CRI) and/or an SSB resource indicator (SSBRI).

In certain aspects, the codebook may have linear combination constraint(s) on certain subsets of CSI-RS/SSB resources, for example, as described herein with respect to FIGS. 10A-10C. The UE may be configured with one or more constraints associated with the codebook on whether one or more linear combinations are applied in the PMI feedback to one or more of the CSI-RS or SSB resources or one or more of the subsets. For example, the UE may receive signaling, from the network entity, indicating one or more constraints associated with the codebook on whether one or more linear combinations are applied in the PMI feedback to one or more of the CSI-RS or SSB resources.

As examples, the constraints may include a first constraint that a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset are not allowed to (cannot) be linearly combined in the PMI feedback. The constraints may include a second constraint that, for a subband-specific linear combination PMI report or a frequency domain-compressed subband-specific linear combination PMI report, different subbands comprise different constraints. The constraints may include a third constraint that, for the subband-specific linear combination PMI report or the frequency domain-compressed subband-specific linear combination PMI report, different subbands comprise a same constraint. The constraints may include the first constraint, the second constraint, the third constraint, or any combination thereof.

In certain aspects, the codebook may have amplitude (power) constraints on feedback coefficients for certain subsets of CSI-RS/SSB resources, for example, as described herein with respect to FIG. 11. The UE may be configured with one or more constraints associated with the codebook on amplitudes of linear combination coefficients associated with one or more of the CSI-RS or SSB resources selected for the PMI feedback. For example, the UE may receive signaling, from the network entity, that indicates one or more constraints associated with the codebook on amplitudes of linear combination coefficients associated with one or more of the CSI-RS or SSB resources selected for the PMI feedback. The constraints may include that a total combined power or an average power for a subset of the CSI-RS or SSB resources is greater (e.g., larger) than a first threshold or less than a second threshold. In certain aspects, the first threshold and/or the second threshold may depend on a ratio of a total number of resources in the one or more subsets selected for the PMI feedback to a total number of the CSI-RS or SSB resources. The first threshold and/or the second threshold depends on resources in the one or more subsets selected for the PMI feedback.

In certain cases, a UE may be capable of processing a certain number of simultaneous CSI processing activities and/or CSI calculations, where simultaneous may refer to occurring at the same period of time, for example, occurring within the same symbol . . . . A CSI processing unit may include one or more CSI processing activities or calculations. For example, if a UE supports N_{CPU} simultaneous CSI calculations, the UE is said to have N_{CPU} CSI processing units for processing CSI reports. If/CPUs are occupied for calculation of CSI reports in a given OFDM symbol (or other suitable duration), the UE has N_{CPU}—L unoccupied CPUs. A UE may not be expected to process CSI calculations that occupy more than the N_{CPU} in a given symbol.

The number of occupied CPUs for the PMI feedback reporting described herein may be determined based on various criteria. In certain cases, the number of occupied CPUs may be determined based on the number of CSI-RS/SSB resources configured for the PMI feedback. For example, if X CSI-RS are configured in the CSI report setting for the PMI feedback, the corresponding number of occupied CPUs may be equal to a·X, where the value of a may be standards predefined, network configured, and/or UE determined and recommended to the network.

In some cases, the number of occupied CPUs may be determined based on periodicities of the CSI-RS/SSB resources. If the CSI-RS/SSB resources configured for the PMI feedback have different periodicities, the number of occupied CPUs may depend on the number of CSI-RS/SSB resources associated with each periodicity and the duration of each periodicity. For example, if X SSB resources have a periodicity of M-ms and the Y CSI-RS resources have a periodicity of N-ms, the corresponding number of occupied CPUs may be equal to

$$\frac{a}{M} X + \frac{b}{N} Y ,$$

where the values of a and b can be standards predefined, network configured, and/or UE determined and recommended to the network.

In certain cases, the number of occupied CPUs may be determined based on the number of selected CSI-RS/SSB resources in the codebook, and/or the ratio of the number of selected CSI-RS/SSB resource to the total number of configured CSI-RS/SSB resources. For example, if X CSI-RS are configured in the CSI report setting for the PMI feedback, x CSI-RS resources are selected from the X CSI-RS for the PMI feedback, the corresponding number of occupied CPUs may be equal to

$$\frac{ax}{X} ,$$

where the value of a may be standards predefined, network configured, and/or UE determined and recommended to the network.

In some cases, the number of occupied CPUs may be determined based on the bandwidth of subbands, the number of subbands, or the subband size for subband-specific PMI reports. In certain cases, the number of occupied CPUs may be determined based on the number of FD compression bases for subband-specific PMI reports.

The UE may process the CSI in compliance with a threshold (e.g., N_{CPU} simultaneous CSI calculations) for simultaneous CSI calculations. For example, the UE may process the CSI if the number of simultaneous CSI calculations (e.g., the number of occupied CPUs) for the CSI and/or other CSI processing operations in one or more symbols is less than or equal to the threshold. The number for the simultaneous CSI calculations (e.g., the number of occupied CPUs) associated with the CSI report setting for the PMI feedback may be based at least in part on a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.

For certain aspects, the CSI report setting may identify the codebook via a particular codebook type, for example, a release specific codebook setting that configures a time division multiplexed CSI-RS/SSB resource selection codebook. The CSI-RS/SSB resource selection codebook may be configured as a separate codebook configuration in the CSI report setting. As an example, the codebook configuration may be specific to Release 19 of 3GPPP standards for 5G NR systems (e.g., CodebookConfig-r19). In some cases, the codebook configuration may be specific to a purpose or a particular codebook type, such as a time division multiplexed CSI-RS/SSB resource selection codebook. The CSI report setting may identify the codebook via a particular codebook type.

In certain aspects, the UE may determine PMI feedback using artificial intelligence, machine learning, and/or regression analysis, for example, as described herein with respect to FIGS. 6 and 7. For example, the UE may measure properties associated with a first subset of the CSI-RS/SSB resources and determine the PMI feedback (e.g., quantized combination coefficients for the precoding matrix) for a second subset of CSI-RS/SSB resources based on the measured properties associated with the first subset of CSI-RS/SSB resources using artificial intelligence, machine learning, and/or regression analysis. In some cases, the UE may determine future predictions for properties associated with the CSI-RS/SSB resource selected for PMI feedback using artificial intelligence, machine learning, and/or regression analysis.

The UE may be configured (by the network) with one or more machine learning-based models to report the PMI feedback associated with the CSI-RS/SSB resource selection codebook. The input of the machine learning models may be the monitored CSI-RS/SSB resources and/or or channels estimated from the measured CSI-RS/SSB resources, and the output of the machine learning models may be the PMI feedback. The machine learning models may be based on neural networks and/or kernel-based methods. The UE may receive signaling indicating one or more machine learning models for processing the PMI feedback, and the UE may process the PMI feedback using the one or more machine learning models. The UE may determine matrix components (e.g., precoding matrix component) defined by the codebook using the one or more machine learning models with input including the CSI-RS or SSB resources or one or more channels estimated based on the CSI-RS or SSB resources.

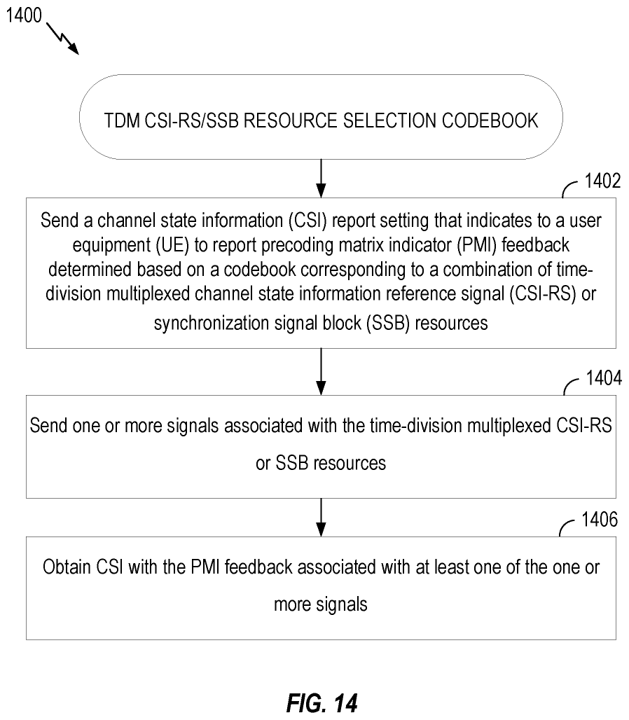

FIG. 14 is a flow diagram illustrating example operations 1400 for wireless communication, in accordance with certain aspects of the present disclosure. The operations 1400 may be performed, for example, by a network entity (such as the BS 102 in the wireless communication network 100). The operations 1400 may be complementary to the operations 1300 performed by the UE. The operations 1400 may be implemented as software components that are executed and run on one or more processors (e.g., controller/processor 240 of FIG. 2). Further, the transmission and reception of signals by the network entity in operations 1400 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, the network entity may refer to a wireless communication device in a radio access network, such as a base station, a remote radio head or antenna panel in communication with a base station, and/or a network controller.

The operations 1400 may optionally begin, at block 1402, where the network entity may send (e.g., provide, output, and/or transmit), to a UE (e.g., the UE 104), a CSI report setting that indicates to a UE to report PMI feedback determined based on a codebook corresponding to a combination of time-division multiplexed CSI-RS or SSB resources. In certain aspects, the network entity may transmit one or more resource settings identifying the CSI-RS or SSB resources associated with the CSI report setting.

At block 1404, the network entity may send one or more signals associated with the time-division multiplexed CSI-RS or SSB resources, for example, as described herein with respect to FIG. 9.

At block 1406, the network entity may obtain (e.g., receive) CSI with the PMI feedback associated with at least one of the one or more signals. For example, the PMI feedback may provide quantized combination coefficients of a precoding matrix for a subset of the CSI-RS/SSB resources.

The PMI feedback, as determined according to the codebook, may include feedback (e.g., coefficients for a precoding matrix) associated with one or more subsets of the CSI-RS or SSB resources (selected by the UE) for the PMI feedback. The PMI feedback may include quantized combination coefficients of the CSI-RS or SSB resources. In certain aspects, the PMI feedback may include a combined RSRP or a combined SINR for the combination of the CSI-RS or SSB resources or a subset of the CSI-RS or SSB resources.

In certain aspects, the PMI feedback may be based on past measurements of the CSI-RS/SSB resources or future predictions of beams associated with the CSI-RS/SSB resources, for example, as described herein with respect to the operations 1300. The CSI report setting may further indicate that the PMI feedback includes one or more past measurements or one or more future predictions based on the CSI-RS or SSB resources.

For certain aspects, the codebook may have a set number of resources in a subset of the CSI-RS/SSB resources and/or a set number of subsets of the CSI-RS/SSB resources for the PMI feedback, for example, as described herein with respect to the operations 1300. For example, the number of CSI-RS/SSB resources within a subset of CSI-RS/SSB resources and/or the number of subsets can be predefined, configured by the network (e.g., the network entity of the operations 1400), and/or determined by the UE and recommended to the network. In some cases, the codebook may include a preconfigured first number of resources in each of the one or more subsets, a preconfigured second number of the one or more subsets, or any combination thereof. In certain cases, the network entity may transmit signaling that indicates a first number of resources in each of the one or more subsets, a second number of the one or more subsets, or any combination thereof. In some cases, the network entity may receive, from the UE, an indication of a first number of resources in each of the one or more subsets, a second number of the one or more subsets, or any combination thereof.

The number of CSI-RS/SSB resources in a subset and the number of subsets may be common among layers, specific to a layer, common among ranks, and/or specific to a rank, for example, as described herein with respect to the operations 1300. A first number of resources in each of the one or more subsets or a second number of the one or more subsets may be different for different layers associated with the PMI feedback or different for different rank indicators associated with the PMI feedback. In certain cases, a first number of resources in each of the one or more subsets or a second number of the one or more subsets may be common for different layers associated with the PMI feedback or common for different rank indicators that are associated with the PMI feedback.

In certain aspects, the PMI feedback may provide a wideband report, a subband report, and/or a FD compression of a subband report. The quantized combination coefficients in the PMI feedback may be based on a wideband-specific linear combination associated with resources in the one or more subsets, a subband-specific linear combination associated with resources in the one or more subsets, a FD compression of a subband-specific linear combination associated with resources in the one or more subsets, or any combination thereof.

For certain aspects, the network entity may receive, from the UE, an indication of the CSI-RS/SSB resources selected for the PMI feedback. The network entity may receive the indication in the PMI feedback or separate uplink signaling from the UE. For example, the PMI feedback may indicate the one or more subsets of the CSI-RS or SSB resources selected for the PMI feedback through an indication of components within a matrix (e.g., a precoding matrix) as the one or more subsets of the CSI-RS or SSB resources, where different components within the matrix identify different CSI-RS or SSB resources; resource indicators for resources in the one or more subsets of the CSI-RS or SSB resources; or any combination thereof.

In certain aspects, the codebook may have linear combination constraint(s) on certain subsets of CSI-RS/SSB resources, for example, as described herein with respect to FIGS. 10A-10C and the operations 1300. The network entity may transmit signaling that indicates one or more constraints associated with the codebook on whether one or more linear combinations are applied in the PMI feedback to one or more of the CSI-RS or SSB resources.

As examples, the constraints may include a first constraint that a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset cannot be linearly combined in the PMI feedback. The constraints may include a second constraint that, for a subband-specific linear combination PMI report or a frequency domain-compressed subband-specific linear combination PMI report, different subbands comprise different constraints. The constraints may include a third constraint that, for the subband-specific linear combination PMI report or the frequency domain-compressed subband-specific linear combination PMI report, different subbands comprise a same constraint. The constraints may include the first constraint, the second constraint, the third constraint, or any combination thereof.

In certain aspects, the codebook may have amplitude (power) constraints on feedback coefficients for certain subsets of CSI-RS/SSB resources, for example, as described herein with respect to FIG. 11 and the operations 1300. The network entity may transmit signaling that indicates one or more constraints associated with the codebook on amplitudes of linear combination coefficients associated with one or more of the CSI-RS or SSB resources selected for the PMI feedback. The constraints may include that a total combined power or an average power for a subset of the CSI-RS or SSB resources is greater (e.g., larger) than a first threshold or less than a second threshold. In certain aspects, the first threshold and/or the second threshold may depend on a ratio of a total number of resources in the one or more subsets selected for the PMI feedback to a total number of the CSI-RS or SSB resources. The first threshold and/or the second threshold depends on resources in the one or more subsets selected for the PMI feedback.

The number of occupied CPUs for the PMI feedback reporting described herein may be determined based on various criteria, for example, as described herein with respect to the operations 1300. The number for the simultaneous CSI calculations (e.g., the number of occupied CPUs) associated with the CSI report setting for the PMI feedback may be based at least in part on a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.

For certain aspects, the CSI report setting may identify the codebook via a particular codebook type, for example, as described herein with respect to the operations 1300.

In certain aspects, the network entity may configure the UE with certain settings to determine the PMI feedback using artificial intelligence, machine learning, and/or regression analysis, for example, as described herein with respect to FIGS. 6 and 7. For example, the network entity may transmit signaling indicating one or more machine learning models for processing the PMI feedback.

Deployment of communication systems, such as 5G new radio (NR) systems, may be arranged in multiple manners with various components or constituent parts. In a 5G NR system (or network), a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

### Example Disaggregated RAN

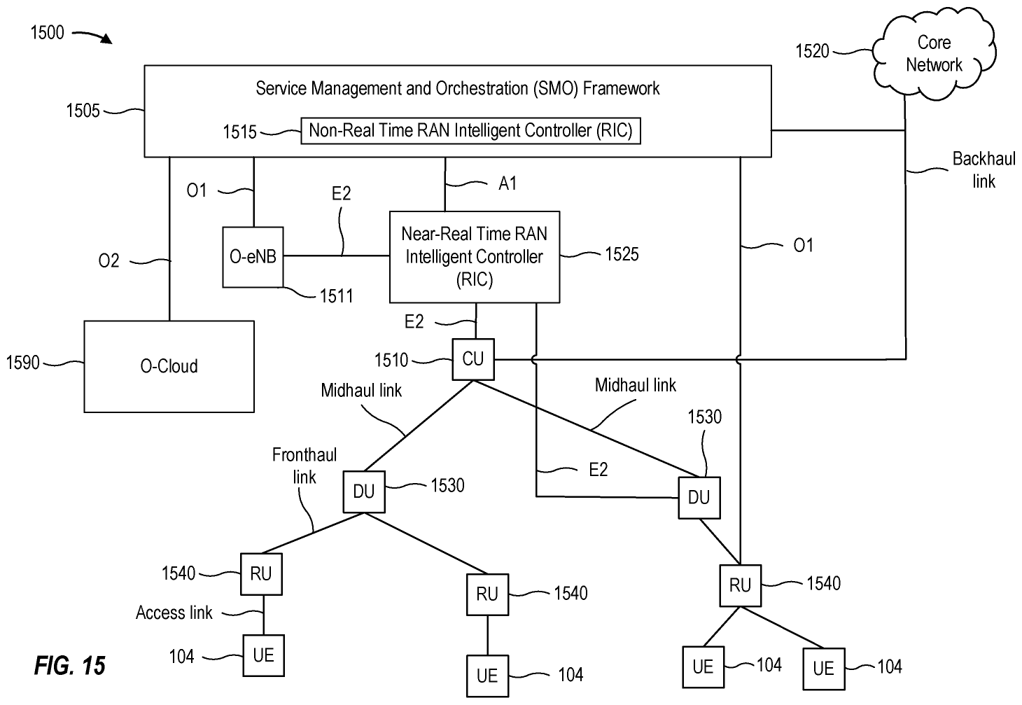

FIG. 15 shows a diagram illustrating an example disaggregated base station 1500 architecture. The disaggregated base station 1500 architecture may include one or more central units (CUs) 1510 that can communicate directly with a core network 1520 via a backhaul link, or indirectly with the core network 1520 through one or more disaggregated base station units (such as a Near-Real Time (Near-RT) RAN Intelligent Controller (RIC) 1525 via an E2 link, or a Non-Real Time (Non-RT) RIC 1515 associated with a Service Management and Orchestration (SMO) Framework 1505, or both). A CU 1510 may communicate with one or more distributed units (DUs) 1530 via respective midhaul links, such as an F1 interface. The DUs 1530 may communicate with one or more radio units (RUs) 1540 via respective fronthaul links. The RUs 1540 may communicate with respective UEs 104 via one or more radio frequency (RF) access links. In some implementations, the UE 104 may be simultaneously served by multiple RUs 1540.

Each of the units, i.e., the CUs 1510, the DUs 1530, the RUs 1540, as well as the Near-RT RICs 1525, the Non-RT RICs 1515 and the SMO Framework 1505, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 1510 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1510. The CU 1510 may be configured to handle user plane functionality (i.e., Central Unit-User Plane (CU-UP)), control plane functionality (i.e., Central Unit-Control Plane (CU-CP)), or a combination thereof. In some implementations, the CU 1510 can be logically split into one or more CU-UP units and one or more CU-CP units. The CU-UP unit can communicate bidirectionally with the CU-CP unit via an interface, such as the E1 interface when implemented in an O-RAN configuration. The CU 1510 can be implemented to communicate with the DU 1530, as necessary, for network control and signaling.

The DU 1530 may correspond to a logical unit that includes one or more base station functions to control the operation of one or more RUs 1540. In some aspects, the DU 1530 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1530 may further host one or more low PHY layers. Each layer (or module) can be implemented with an interface configured to communicate signals with other layers (and modules) hosted by the DU 1530, or with the control functions hosted by the CU 1510.

Lower-layer functionality can be implemented by one or more RUs 1540. In some deployments, an RU 1540, controlled by a DU 1530, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1540 can be implemented to handle over the air (OTA) communication with one or more UEs 104. In some implementations, real-time and non-real-time aspects of control and user plane communication with the RU(s) 1540 can be controlled by the corresponding DU 1530. In some scenarios, this configuration can enable the DU(s) 1530 and the CU 1510 to be implemented in a cloud-based RAN architecture, such as a vRAN architecture.

The SMO Framework 1505 may be configured to support RAN deployment and provisioning of non-virtualized and virtualized network elements. For non-virtualized network elements, the SMO Framework 1505 may be configured to support the deployment of dedicated physical resources for RAN coverage requirements which may be managed via an operations and maintenance interface (such as an O1 interface). For virtualized network elements, the SMO Framework 1505 may be configured to interact with a cloud computing platform (such as an open cloud (O-Cloud) 1590) to perform network element life cycle management (such as to instantiate virtualized network elements) via a cloud computing platform interface (such as an 02 interface). Such virtualized network elements can include, but are not limited to, CUs 1510, DUs 1530, RUs 1540 and Near-RT RICs 1525. In some implementations, the SMO Framework 1505 can communicate with a hardware aspect of a 4G RAN, such as an open eNB (O-eNB) 1511, via an O1 interface. Additionally, in some implementations, the SMO Framework 1505 can communicate directly with one or more RUs 1540 via an O1 interface. The SMO Framework 1505 also may include a Non-RT RIC 1515 configured to support functionality of the SMO Framework 1505.

The Non-RT RIC 1515 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1525. The Non-RT RIC 1515 may be coupled to or communicate with (such as via an A1 interface) the Near-RT RIC 1525. The Near-RT RIC 1525 may be configured to include a logical function that enables near-real-time control and optimization of RAN elements and resources via data collection and actions over an interface (such as via an E2 interface) connecting one or more CUs 1510, one or more DUs 1530, or both, as well as an O-eNB, with the Near-RT RIC 1525.

In some implementations, to generate AI/ML models to be deployed in the Near-RT RIC 1525, the Non-RT RIC 1515 may receive parameters or external enrichment information from external servers. Such information may be utilized by the Near-RT RIC 1525 and may be received at the SMO Framework 1505 or the Non-RT RIC 1515 from non-network data sources or from network functions. In some examples, the Non-RT RIC 1515 or the Near-RT RIC 1525 may be configured to tune RAN behavior or performance. For example, the Non-RT RIC 1515 may monitor long-term trends and patterns for performance and employ AI/ML models to perform corrective actions through the SMO Framework 1505 (such as reconfiguration via 01) or via creation of RAN management policies (such as A1 policies).

### Example Wireless Communication Devices

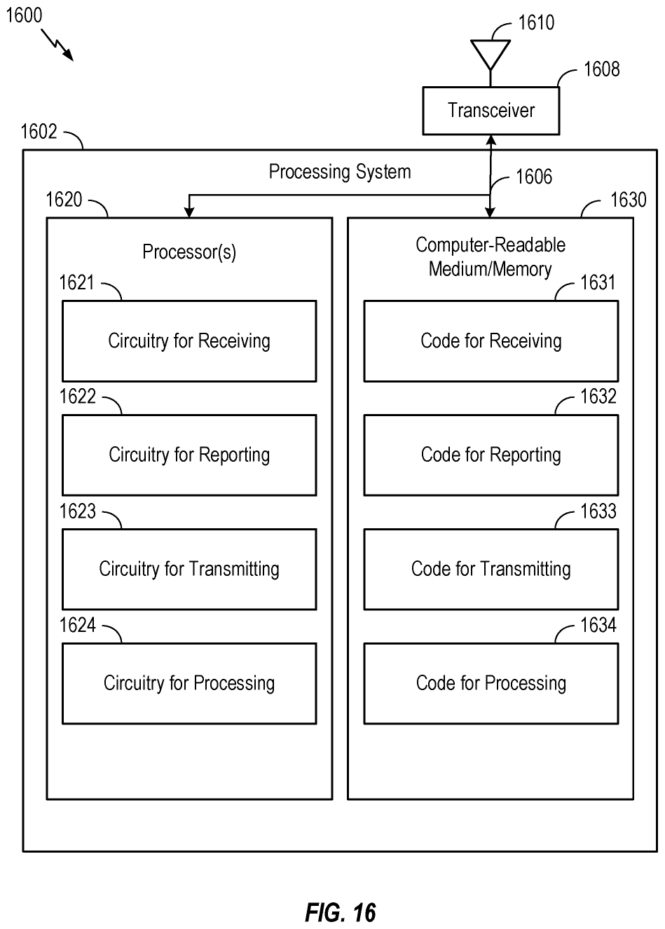

FIG. 16 depicts an example communications device 1600 that includes various components operable, configured, or adapted to perform operations for the techniques disclosed herein, such as the operations depicted and described with respect to FIGS. 8-13. In some examples, communication device 1600 may be a UE 104 as described, for example with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIGS. 8-13, or other operations for performing the various techniques discussed herein for codebook-based precoding with a time division multiplexed CSI-RS/SSB resource selection codebook.

In the depicted example, computer-readable medium/memory 1630 stores code 1631 for receiving, code 1632 for reporting, code 1633 for transmitting, and/or code 1634 for processing.

In the depicted example, the one or more processors 1620 include circuitry configured to implement the code stored in the computer-readable medium/memory 1630, including circuitry 1621 for receiving, circuitry 1622 for reporting, circuitry 1623 for transmitting, and/or circuitry 1624 for processing.

Various components of communications device 1600 may provide means for performing the methods described herein, including with respect to FIGS. 8-13.

In some examples, means for transmitting, reporting, or sending (or means for outputting for transmission) may include the transceivers 254 and/or antenna(s) 252 of the UE 104 illustrated in FIG. 2 and/or transceiver 1608 and antenna 1610 of the communication device 1600 in FIG. 16.

In some examples, means for receiving (or means for obtaining) may include the transceivers 254 and/or antenna(s) 252 of the UE 104 illustrated in FIG. 2 and/or transceiver 1608 and antenna 1610 of the communication device 1600 in FIG. 16.

In some examples, means for reporting and/or means for processing or determining may include various processing system components, such as: the one or more processors 1620 in FIG. 16, or aspects of the UE 104 depicted in FIG. 2, including receive processor 258, transmit processor 264, TX MIMO processor 266, and/or controller/processor 280 (including the TDM CSI-RS/SSB resource selection component 281).

Notably, FIG. 16 is an example, and many other examples and configurations of communication device 1600 are possible.

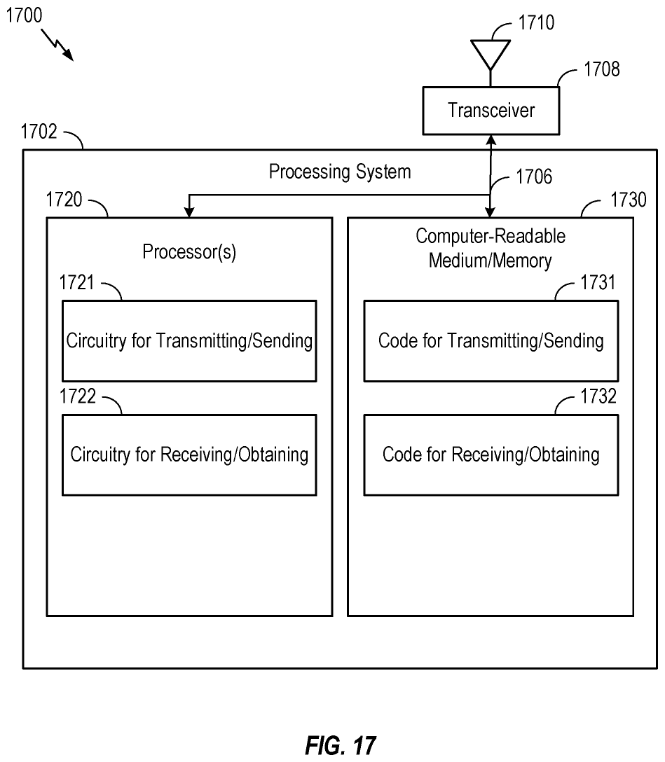

FIG. 17 depicts an example communications device 1700 that includes various components operable, configured, or adapted to perform operations for the techniques disclosed herein, such as the operations depicted and described with respect to FIGS. 8-12C and 14. In some examples, communication device 1700 may be a BS 102 as described, for example with respect to FIGS. 1 and 2.

Communications device 1700 includes a processing system 1702 coupled to a transceiver 1708 (e.g., a transmitter and/or a receiver). Transceiver 1708 is configured to transmit (or send) and receive signals for the communications device 1700 via an antenna 1710, such as the various signals as described herein. Processing system 1702 may be configured to perform processing functions for communications device 1700, including processing signals received and/or to be transmitted by communications device 1700.

Processing system 1702 includes one or more processors 1720 coupled to a computer-readable medium/memory 1730 via a bus 1706. In certain aspects, computer-readable medium/memory 1730 is configured to store instructions (e.g., computer-executable code) that when executed by the one or more processors 1720, cause the one or more processors 1720 to perform the operations illustrated in FIGS. 8-12C and 14, or other operations for performing the various techniques discussed herein for codebook-based precoding with a time division multiplexed CSI-RS/SSB resource selection codebook.

In the depicted example, computer-readable medium/memory 1730 stores code 1731 for transmitting/sending and/or code 1732 for receiving/obtaining.

In the depicted example, the one or more processors 1720 include circuitry configured to implement the code stored in the computer-readable medium/memory 1730, including circuitry 1721 for transmitting/sending and/or circuitry 1722 for receiving/obtaining.

Various components of communications device 1700 may provide means for performing the methods described herein, including with respect to FIGS. 8-12C and 14.

In some examples, means for transmitting or sending (or means for outputting for transmission) may include the transceivers 232 and/or antenna(s) 234 of the BS 102 illustrated in FIG. 2 and/or transceiver 1708 and antenna 1710 of the communication device 1700 in FIG. 17.

In some examples, means for receiving (or means for obtaining) may include the transceivers 232 and/or antenna(s) 234 of the base station illustrated in FIG. 2 and/or transceiver 1708 and antenna 1710 of the communication device 1700 in FIG. 17.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for transmitting and/or receiving may include various processing system components, such as: the one or more processors 1720 in FIG. 17, or aspects of the BS 102 depicted in FIG. 2, including receive processor 238, transmit processor 220, TX MIMO processor 230, and/or controller/processor 240 (including the TDM CSI-RS/SSB resource selection component 241).

Notably, FIG. 17 is an example, and many other examples and configurations of communication device 1700 are possible.

### Example Aspects

Implementation examples are described in the following numbered clauses:
Aspect 1: An apparatus for wireless communication, comprising: a memory; and a processor coupled to the memory, the processor and the memory being configured to: receive a channel state information (CSI) report setting indicating to report precoding matrix indicator (PMI) feedback determined based on a codebook corresponding to a combination of time-division multiplexed CSI reference signal (CSI-RS) or synchronization signal block (SSB) resources, and report CSI with the PMI feedback associated with one or more resources in the time-division multiplexed CSI-RS or SSB resources.
Aspect 2: The apparatus of Aspect 1, wherein the PMI feedback, as determined based on the codebook, includes: feedback associated with one or more subsets of the CSI-RS or SSB resources selected for the PMI feedback; quantized combination coefficients of the CSI-RS or SSB resources; a combined reference signal received power (RSRP) or a combined signal-to-interference-plus-noise ratio (SINR) for the combination of the CSI-RS or SSB resources; or any combination thereof.
Aspect 3: The apparatus of Aspect 1 or 2, wherein the processor is further configured to receive one or more resource settings identifying the CSI-RS or SSB resources associated with the CSI report setting.
Aspect 4: The apparatus according to any of Aspects 1-3, wherein the CSI report setting further indicates that the PMI feedback includes one or more past measurements or one or more future predictions based on the CSI-RS or SSB resources.
Aspect 5: The apparatus according to any of Aspects 2-4, wherein the quantized combination coefficients are based on: a wideband-specific linear combination associated with resources in the one or more subsets, a subband-specific linear combination associated with resources in the one or more subsets, a frequency domain compression of a subband-specific linear combination associated with resources in the one or more subsets, or any combination thereof.
Aspect 6: The apparatus according to any of Aspects 2-4, wherein the PMI feedback indicates the one or more subsets of the CSI-RS or SSB resources selected for the PMI feedback through: an indication of components within a matrix as the one or more subsets of the CSI-RS or SSB resources, wherein different components within the matrix identify different CSI-RS or SSB resources; resource indicators for resources in the one or more subsets of the CSI-RS or SSB resources; or any combination thereof.
Aspect 7: The apparatus according to any of Aspects 1-6, wherein the processor is further configured to receive signaling that indicates one or more constraints associated with the codebook on whether one or more linear combinations are applied in the PMI feedback to one or more of the CSI-RS or SSB resources.
Aspect 8: The apparatus of Aspect 7, wherein the one or more constraints include: a first constraint that: a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset are not allowed to be linearly combined in the PMI feedback; a second constraint that, for a subband-specific linear combination PMI report or a frequency domain-compressed subband-specific linear combination PMI report, different subbands comprise different constraints; a third constraint that, for the subband-specific linear combination PMI report or the frequency domain-compressed subband-specific linear combination PMI report, different subbands comprise a same constraint; or any combination thereof.
Aspect 9: The apparatus according to any of Aspects 2-8, wherein the processor is further configured to receive signaling that indicates one or more constraints associated with the codebook on amplitudes of linear combination coefficients associated with one or more of the CSI-RS or SSB resources selected for the PMI feedback.
Aspect 10: The apparatus of Aspect 9, wherein the one or more constraints include that a total combined power or an average power for a subset of the CSI-RS or SSB resources is greater than a first threshold or less than a second threshold.
Aspect 11: The apparatus according to any of Aspects 2-10, wherein the processor is further configured to process the CSI in compliance with a threshold for simultaneous CSI calculations, wherein a number for the simultaneous CSI calculations associated with the CSI report setting is based at least in part on: a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.
Aspect 12: The apparatus according to any of Aspects 1-11, wherein the CSI report setting identifies the codebook via a particular codebook type.
Aspect 13: The apparatus according to any of Aspect 1-12, wherein the processor is further configured to: receive signaling indicating one or more machine learning models for processing the PMI feedback; and report the CSI comprises processing the PMI feedback using the one or more machine learning models.
Aspect 14: The apparatus of Aspect 13, wherein the processor is further configured to: determine matrix components defined by the codebook using the one or more machine learning models with input including the CSI-RS or SSB resources or one or more channels estimated based on the CSI-RS or SSB resources, wherein the one or more machine learning models are based on neural networks or kernel-based methods.
Aspect 15: An apparatus for wireless communication, comprising: a memory; and a processor coupled to the memory, the processor and the memory being configured to: transmit a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources, transmit one or more signals associated with the time-division multiplexed CSI-RS or SSB resources, and receive CSI with the PMI feedback associated with at least one of the one or more signals.
Aspect 16: The apparatus of Aspect 15, wherein the PMI feedback, based on the codebook, includes: feedback associated with one or more subsets of the CSI-RS or SSB resources for the PMI feedback; quantized combination coefficients of the CSI-RS or SSB resources; a combined reference signal received power (RSRP) or a combined signal-to-interference-plus-noise ratio (SINR) for the combination of the CSI-RS or SSB resources; or any combination thereof.
Aspect 17: The apparatus of Aspect 15 or 16, wherein the processor is further configured to transmit one or more resource settings identifying the CSI-RS or SSB resources associated with the CSI report setting.
Aspect 18: The apparatus according to any of Aspects 15-17, wherein the CSI report setting further indicates that the PMI feedback includes one or more past measurements or one or more future predictions based on the CSI-RS or SSB resources.
Aspect 19: The apparatus according to any of Aspects 16-18, wherein the quantized combination coefficients are based on: a wideband-specific linear combination associated with resources in the one or more subsets, a subband-specific linear combination associated with resources in the one or more subsets, a frequency domain compression of a subband-specific linear combination associated with resources in the one or more subsets, or any combination thereof.
Aspect 20: The apparatus according to any of Aspects 16-19, wherein the PMI feedback indicates the one or more subsets of the CSI-RS or SSB resources for the PMI feedback through: an indication of components within a matrix as the one or more subsets of the CSI-RS or SSB resources, wherein different components within the matrix identify different CSI-RS or SSB resources; resource indicators for resources in the one or more subsets of the CSI-RS or SSB resources; or any combination thereof.
Aspect 21: The apparatus according to any of Aspects 15-20, wherein the processor is further configured to transmit signaling that indicates one or more constraints associated with the codebook on whether one or more linear combinations are applied in the PMI feedback to one or more of the CSI-RS or SSB resources.
Aspect 22: The apparatus of Aspect 21, wherein the one or more constraints include: a first constraint that: a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset are not allowed to be linearly combined in the PMI feedback; a second constraint that, for a subband-specific linear combination PMI report or a frequency domain-compressed subband-specific linear combination PMI report, different subbands comprise different constraints; a third constraint that, for the subband-specific linear combination PMI report or the frequency domain-compressed subband-specific linear combination PMI report, different subbands comprise a same constraint; or any combination thereof.
Aspect 23: The apparatus according to any of Aspects 15-22, wherein the processor is further configured to transmit signaling that indicates one or more constraints associated with the codebook on amplitudes of linear combination coefficients associated with one or more of the CSI-RS or SSB resources for the PMI feedback.
Aspect 24: The apparatus of Aspect 23, wherein the one or more constraints include that a total combined power or an average power for a subset of the CSI-RS or SSB resources is greater than a first threshold or less than a second threshold.
Aspect 25: The apparatus according to any of Aspects 16-24, wherein a number for simultaneous CSI calculations associated with the CSI report setting is based at least in part on: a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.
Aspect 26: The apparatus according to any of Aspects 15-25, wherein the CSI report setting identifies the codebook via a particular codebook type.
Aspect 27: The apparatus according to any of Aspects 15-26, wherein the processor is further configured to transmit signaling indicating one or more machine learning models for processing the PMI feedback.
Aspect 28: A method of wireless communication by a user equipment (UE), comprising: receiving a channel state information (CSI) report setting indicating to the UE to report precoding matrix indicator (PMI) feedback determined based on a codebook corresponding to a combination of time-division multiplexed CSI reference signal (CSI-RS) or synchronization signal block (SSB) resources; and reporting CSI with the PMI feedback associated with one or more resources in the time-division multiplexed CSI-RS or SSB resources.
Aspect 29: The method of Aspect 28, wherein the PMI feedback, as determined based on the codebook, includes: feedback associated with one or more subsets of the CSI-RS or SSB resources selected for the PMI feedback; quantized combination coefficients of the CSI-RS or SSB resources; a combined reference signal received power (RSRP) or a combined signal-to-interference-plus-noise ratio (SINR) for the combination of the CSI-RS or SSB resources; or any combination thereof.
Aspect 30: The method of Aspect 28 or 29, wherein receiving comprises receiving one or more resource settings identifying the CSI-RS or SSB resources associated with the CSI report setting.
Aspect 31: The method according to any of Aspects 28-30, wherein the CSI report setting further indicates that the PMI feedback includes one or more past measurements or one or more future predictions based on the CSI-RS or SSB resources.
Aspect 32: The method according to any of Aspects 29-31, wherein the codebook includes: a preconfigured first number of resources in each of the one or more subsets, a preconfigured second number of the one or more subsets, or any combination thereof.
Aspect 33: The method according to any of Aspects 29-31, wherein receiving comprises receiving signaling that indicates: a first number of resources in each of the one or more subsets, a second number of the one or more subsets, or any combination thereof.
Aspect 34: The method according to any of Aspects 29-31, further comprising transmitting, to a network entity, an indication of: a first number of resources in each of the one or more subsets, a second number of the one or more subsets, or any combination thereof.
Aspect 35: The method according to any of Aspects 29-34, wherein a first number of resources in each of the one or more subsets or a second number of the one or more subsets is different for different layers associated with the PMI feedback or different for different rank indicators associated with the PMI feedback.
Aspect 36: The method according to any of Aspects 29-34, wherein a first number of resources in each of the one or more subsets or a second number of the one or more subsets is common for different layers associated with the PMI feedback or common for different rank indicators that are associated with the PMI feedback.
Aspect 37: The method according to any of Aspects 29-36, wherein the quantized combination coefficients are based on: a wideband-specific linear combination associated with resources in the one or more subsets, a subband-specific linear combination associated with resources in the one or more subsets, a frequency domain compression of a subband-specific linear combination associated with resources in the one or more subsets, or any combination thereof.
Aspect 38: The method according to any of Aspects 29-37, wherein the PMI feedback indicates the one or more subsets of the CSI-RS or SSB resources selected for the PMI feedback through: an indication of components within a matrix as the one or more subsets of the CSI-RS or SSB resources, wherein different components within the matrix identify different CSI-RS or SSB resources; resource indicators for resources in the one or more subsets of the CSI-RS or SSB resources; or any combination thereof.
Aspect 39: The method according to any of Aspects 28-38, wherein receiving comprises receiving signaling that indicates one or more constraints associated with the codebook on whether one or more linear combinations are applied in the PMI feedback to one or more of the CSI-RS or SSB resources.
Aspect 40: The method of Aspect 39, wherein the one or more constraints include: a first constraint that: a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset are not allowed to be linearly combined in the PMI feedback; a second constraint that, for a subband-specific linear combination PMI report or a frequency domain-compressed subband-specific linear combination PMI report, different subbands comprise different constraints; a third constraint that, for the subband-specific linear combination PMI report or the frequency domain-compressed subband-specific linear combination PMI report, different subbands comprise a same constraint; or any combination thereof.
Aspect 41: The method according to any of Aspects 29-40, wherein receiving comprises receiving signaling that indicates one or more constraints associated with the codebook on amplitudes of linear combination coefficients associated with one or more of the CSI-RS or SSB resources selected for the PMI feedback.
Aspect 42: The method of Aspect 41, wherein the one or more constraints include that a total combined power or an average power for a subset of the CSI-RS or SSB resources is greater than a first threshold or less than a second threshold.
Aspect 43: The method of Aspect 42, wherein the first threshold or the second threshold depends on a ratio of a total number of resources in the one or more subsets selected for the PMI feedback to a total number of the CSI-RS or SSB resources.
Aspect 44: The method of Aspect 42 or 43, wherein the first threshold or the second threshold depends on resources in the one or more subsets selected for the PMI feedback.
Aspect 45: The method according to any of Aspects 29-44, wherein reporting the CSI comprises processing the CSI in compliance with a threshold for simultaneous CSI calculations, wherein a number for the simultaneous CSI calculations associated with the CSI report setting is based at least in part on: a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.
Aspect 46: The method according to any of Aspects 28-45, wherein the CSI report setting identifies the codebook via a particular codebook type.
Aspect 47: The method according to any of Aspects 28-46, wherein: receiving comprises receiving signaling indicating one or more machine learning models for processing the PMI feedback; and reporting the CSI comprises processing the PMI feedback using the one or more machine learning models.
Aspect 48: The method of Aspect 47, wherein processing the PMI feedback comprises: determining matrix components defined by the codebook using the one or more machine learning models with input including the CSI-RS or SSB resources or one or more channels estimated based on the CSI-RS or SSB resources, wherein the one or more machine learning models are based on neural networks or kernel-based methods.
Aspect 49: A method of wireless communication by a network entity, comprising: transmitting a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources; transmitting one or more signals associated with the time-division multiplexed CSI-RS or SSB resources; and receiving CSI with the PMI feedback associated with at least one of the one or more signals.
Aspect 50: The method of Aspect 49, wherein the PMI feedback, based on the codebook, includes: feedback associated with one or more subsets of the CSI-RS or SSB resources for the PMI feedback; quantized combination coefficients of the CSI-RS or SSB resources; a combined reference signal received power (RSRP) or a combined signal-to-interference-plus-noise ratio (SINR) for the combination of the CSI-RS or SSB resources; or any combination thereof.
Aspect 51: The method of Aspect 49 or 50, wherein transmitting the CSI report setting comprises transmitting one or more resource settings identifying the CSI-RS or SSB resources associated with the CSI report setting.
Aspect 52: The method according to any of Aspects 49-51, wherein the CSI report setting further indicates that the PMI feedback includes one or more past measurements or one or more future predictions based on the CSI-RS or SSB resources.
Aspect 53: The method according to any of Aspects 50-52, wherein the codebook includes: a preconfigured first number of resources in each of the one or more subsets, a preconfigured second number of the one or more subsets, or any combination thereof.
Aspect 54: The method according to any of Aspects 50-52, wherein transmitting the CSI report setting comprises transmitting signaling that indicates: a first number of resources in each of the one or more subsets, a second number of the one or more subsets, or any combination thereof.
Aspect 55: The method according to any of Aspects 50-52, further comprising receiving, from the UE, an indication of: a first number of resources in each of the one or more subsets, a second number of the one or more subsets, or any combination thereof.
Aspect 56: The method according to any of Aspects 50-55, wherein a first number of resources in each of the one or more subsets or a second number of the one or more subsets is different for different layers associated with the PMI feedback or different for different rank indicators associated with the PMI feedback.
Aspect 57: The method according to any of Aspects 50-55, wherein a first number of resources in each of the one or more subsets or a second number of the one or more subsets is common for different layers associated with the PMI feedback or common for different rank indicators that are associated with the PMI feedback.
Aspect 58: The method according to any of Aspects 50-57, wherein the quantized combination coefficients are based on: a wideband-specific linear combination associated with resources in the one or more subsets, a subband-specific linear combination associated with resources in the one or more subsets, a frequency domain compression of a subband-specific linear combination associated with resources in the one or more subsets, or any combination thereof.
Aspect 59: The method according to any of Aspects 50-58, wherein the PMI feedback indicates the one or more subsets of the CSI-RS or SSB resources for the PMI feedback through: an indication of components within a matrix as the one or more subsets of the CSI-RS or SSB resources, wherein different components within the matrix identify different CSI-RS or SSB resources; resource indicators for resources in the one or more subsets of the CSI-RS or SSB resources; or any combination thereof.
Aspect 60: The method according to any of Aspects 49-59, wherein transmitting the CSI report setting comprises transmitting signaling that indicates one or more constraints associated with the codebook on whether one or more linear combinations are applied in the PMI feedback to one or more of the CSI-RS or SSB resources.
Aspect 61: The method of Aspect 60, wherein the one or more constraints include: a first constraint that: a first subset of the CSI-RS or SSB resources are to be linearly combined in the PMI feedback, a second subset of the CSI-RS or SSB resources are to be linearly combined in the PMI feedback, and a first resource in the first subset and a second resource in the second subset are not allowed to be linearly combined in the PMI feedback; a second constraint that, for a subband-specific linear combination PMI report or a frequency domain-compressed subband-specific linear combination PMI report, different subbands comprise different constraints; a third constraint that, for the subband-specific linear combination PMI report or the frequency domain-compressed subband-specific linear combination PMI report, different subbands comprise a same constraint; or any combination thereof.
Aspect 62: The method according to any of Aspects 49-61, wherein transmitting the CSI report setting comprises transmitting signaling that indicates one or more constraints associated with the codebook on amplitudes of linear combination coefficients associated with one or more of the CSI-RS or SSB resources for the PMI feedback.
Aspect 63: The method of Aspect 62, wherein the one or more constraints include that a total combined power or an average power for a subset of the CSI-RS or SSB resources is greater than a first threshold or less than a second threshold.
Aspect 64: The method of Aspect 63, wherein the first threshold or the second threshold depends on a ratio of a total number of resources in the one or more subsets for the PMI feedback to a total number of the CSI-RS or SSB resources.
Aspect 65: The method of Aspect 63 or 64, wherein the first threshold or the second threshold depends on resources in the one or more subsets for the PMI feedback.
Aspect 66: The method according to any of Aspects 50-65, wherein a number for simultaneous CSI calculations associated with the CSI report setting is based at least in part on: a number of the CSI-RS or SSB resources, a periodicity of the CSI-RS or SSB resources, a number of resources in the one or more subsets, a ratio of a total number of resources in the one or more subsets to a total number of the CSI-RS or SSB resources, a number of subbands or a size of subbands associated with the CSI report setting, a number of frequency domain compression bases associated with the CSI report setting, or any combination thereof.
Aspect 67: The method according to any of Aspects 49-66, wherein the CSI report setting identifies the codebook via a particular codebook type.
Aspect 68: The method according to any of Aspects 49-67, wherein transmitting the CSI report setting comprises transmitting signaling indicating one or more machine learning models for processing the PMI feedback.
Aspect 69: An apparatus, comprising: a memory comprising executable instructions; one or more processors configured to execute the executable instructions and cause the apparatus to perform a method in accordance with any of Aspects 28-68.
Aspect 70: An apparatus, comprising means for performing a method in accordance with any of Aspects 28-68.
Aspect 71: A computer-readable medium comprising executable instructions that, when executed by one or more processors of an apparatus, cause the apparatus to perform a method in accordance with any of Aspects 28-68.
Aspect 72: A computer program product embodied on a computer-readable storage medium comprising code for performing a method in accordance with any of Aspects 28-68.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mmWave frequencies, the BS 180 may be referred to as an mmWave base station.

The communication links 120 between BSs 102 and, for example, UEs 104, may be through one or more carriers. For example, BSs 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology u=0 has a subcarrier spacing of 15 kHz and the numerology u=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 us.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of codebook-based precoding in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user equipment (as in the example UE 104 of FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
a memory; and
a processor coupled to the memory, the processor being configured to:
receive a channel state information (CSI) report setting indicating to report precoding matrix indicator (PMI) feedback determined based on a codebook corresponding to a combination of time-division multiplexed CSI reference signal (CSI-RS) or synchronization signal block (SSB) resources, and
report CSI with the PMI feedback associated with one or more resources in the time-division multiplexed CSI-RS or SSB resources.

2. The apparatus of claim 1, further comprising:
a transceiver coupled to the processor and the memory, wherein the transceiver is configured to receive the CSI report setting and report the CSI; and
wherein the PMI feedback, as determined based on the codebook, includes:
feedback associated with one or more subsets of the CSI-RS or SSB resources selected for the PMI feedback;
quantized combination coefficients of the CSI-RS or SSB resources;
a combined reference signal received power (RSRP) or a combined signal-to-interference-plus-noise ratio (SINR) for the combination of the CSI-RS or SSB resources; or
any combination thereof.

3. The apparatus of claim 1, wherein the processor is further configured to receive one or more resource settings identifying the CSI-RS or SSB resources associated with the CSI report setting.

4. The apparatus of claim 1, wherein the CSI report setting further indicates that the PMI feedback includes one or more past measurements or one or more future predictions based on the CSI-RS or SSB resources.

5. The apparatus of claim 2, wherein the quantized combination coefficients are based on:
a wideband-specific linear combination associated with resources in the one or more subsets,
a subband-specific linear combination associated with resources in the one or more subsets,
a frequency domain compression of a subband-specific linear combination associated with resources in the one or more subsets, or
any combination thereof.

6. The apparatus of claim 2, wherein the PMI feedback indicates the one or more subsets of the CSI-RS or SSB resources selected for the PMI feedback through:
an indication of components within a matrix as the one or more subsets of the CSI-RS or SSB resources, wherein different components within the matrix identify different CSI-RS or SSB resources;
resource indicators for resources in the one or more subsets of the CSI-RS or SSB resources; or
any combination thereof.

7. The apparatus of claim 1, wherein the processor is further configured to receive signaling that indicates one or more constraints associated with the codebook on whether one or more linear combinations are applied in the PMI feedback to one or more of the CSI-RS or SSB resources.

8. The apparatus of claim 7, wherein the one or more constraints include:
a first constraint that:
a first subset of the CSI-RS or SSB resources are to be linearly combined in the PMI feedback,
a second subset of the CSI-RS or SSB resources are to be linearly combined in the PMI feedback, and
a first resource in the first subset and a second resource in the second subset are not allowed to be linearly combined in the PMI feedback;
a second constraint that, for a subband-specific linear combination PMI report or a frequency domain-compressed subband-specific linear combination PMI report, different subbands comprise different constraints;
a third constraint that, for the subband-specific linear combination PMI report or the frequency domain-compressed subband-specific linear combination PMI report, different subbands comprise a same constraint; or
any combination thereof.

9. The apparatus of claim 2, wherein the processor is further configured to receive signaling that indicates one or more constraints associated with the codebook on amplitudes of linear combination coefficients associated with one or more of the CSI-RS or SSB resources selected for the PMI feedback.

10. The apparatus of claim 9, wherein the one or more constraints include that a total combined power or an average power for a subset of the CSI-RS or SSB resources is greater than a first threshold or less than a second threshold.

11. The apparatus of claim 2, wherein the processor is further configured to process the CSI in compliance with a threshold for simultaneous CSI calculations, wherein a number for the simultaneous CSI calculations associated with the CSI report setting is based at least in part on:
a number of the CSI-RS or SSB resources,
a periodicity of the CSI-RS or SSB resources,
a number of resources in the one or more subsets,
a ratio of a total number of resources in the one or more subsets to a total number of the CSI-RS or SSB resources,
a number of subbands or a size of subbands associated with the CSI report setting,
a number of frequency domain compression bases associated with the CSI report setting, or
any combination thereof.

12. The apparatus of claim 1, wherein the CSI report setting identifies the codebook via a particular codebook type.

13. The apparatus of claim 1, wherein the processor is further configured to:
receive signaling indicating one or more machine learning models for processing the PMI feedback; and
report the CSI comprises processing the PMI feedback using the one or more machine learning models.

14. The apparatus of claim 13, wherein the processor is further configured to:
determine matrix components defined by the codebook using the one or more machine learning models with input including the CSI-RS or SSB resources or one or more channels estimated based on the CSI-RS or SSB resources, wherein the one or more machine learning models are based on neural networks or kernel-based methods.

15. An apparatus for wireless communication, comprising:
a memory; and
a processor coupled to the memory, the processor being configured to:
send a channel state information (CSI) report setting indicating to a user equipment (UE) to report precoding matrix indicator (PMI) feedback based on a codebook corresponding to a combination of time-division multiplexed channel state information reference signal (CSI-RS) or synchronization signal block (SSB) resources,
send one or more signals associated with the time-division multiplexed CSI-RS or SSB resources, and
obtain CSI with the PMI feedback associated with at least one of the one or more signals.

16. The apparatus of claim 15, further comprising:
a transceiver coupled to the processor and the memory, wherein the transceiver is configured to send the CSI report setting, send the one or more signals, and obtain the CSI; and
wherein the PMI feedback includes:
feedback associated with one or more subsets of the CSI-RS or SSB resources for the PMI feedback;
quantized combination coefficients of the CSI-RS or SSB resources;
a combined reference signal received power (RSRP) or a combined signal-to-interference-plus-noise ratio (SINR) for the combination of the CSI-RS or SSB resources; or
any combination thereof.

17. The apparatus of claim 15, wherein the processor is further configured to send one or more resource settings identifying the CSI-RS or SSB resources associated with the CSI report setting.

18. The apparatus of claim 15, wherein the CSI report setting further indicates that the PMI feedback includes one or more past measurements or one or more future predictions based on the CSI-RS or SSB resources.

19. The apparatus of claim 16, wherein the quantized combination coefficients are based on:
a wideband-specific linear combination associated with resources in the one or more subsets,
a subband-specific linear combination associated with resources in the one or more subsets,
a frequency domain compression of a subband-specific linear combination associated with resources in the one or more subsets, or
any combination thereof.

20. The apparatus of claim 16, wherein the PMI feedback indicates the one or more subsets of the CSI-RS or SSB resources for the PMI feedback through:
an indication of components within a matrix as the one or more subsets of the CSI-RS or SSB resources, wherein different components within the matrix identify different CSI-RS or SSB resources;
resource indicators for resources in the one or more subsets of the CSI-RS or SSB resources; or
any combination thereof.

21. The apparatus of claim 15, wherein the processor is further configured to send signaling that indicates one or more constraints associated with the codebook on whether one or more linear combinations are applied in the PMI feedback to one or more of the CSI-RS or SSB resources.

22. The apparatus of claim 21, wherein the one or more constraints include:
a first constraint that:
a first subset of the CSI-RS or SSB resources are to be linearly combined in the PMI feedback,
a second subset of the CSI-RS or SSB resources are to be linearly combined in the PMI feedback, and
a first resource in the first subset and a second resource in the second subset are not allowed to be linearly combined in the PMI feedback;
a second constraint that, for a subband-specific linear combination PMI report or a frequency domain-compressed subband-specific linear combination PMI report, different subbands comprise different constraints;
a third constraint that, for the subband-specific linear combination PMI report or the frequency domain-compressed subband-specific linear combination PMI report, different subbands comprise a same constraint; or
any combination thereof.

23. The apparatus of claim 15, wherein the processor is further configured to send signaling that indicates one or more constraints associated with the codebook on amplitudes of linear combination coefficients associated with one or more of the CSI-RS or SSB resources for the PMI feedback.

24. The apparatus of claim 23, wherein the one or more constraints include that a total combined power or an average power for a subset of the CSI-RS or SSB resources is greater than a first threshold or less than a second threshold.

25. The apparatus of claim 16, wherein a number for simultaneous CSI calculations associated with the CSI report setting is based at least in part on:
a number of the CSI-RS or SSB resources,
a periodicity of the CSI-RS or SSB resources,
a number of resources in the one or more subsets,
a ratio of a total number of resources in the one or more subsets to a total number of the CSI-RS or SSB resources,
a number of subbands or a size of subbands associated with the CSI report setting,
a number of frequency domain compression bases associated with the CSI report setting, or
any combination thereof.

26. The apparatus of claim 15, wherein the CSI report setting identifies the codebook via a particular codebook type.

27. The apparatus of claim 15, wherein the processor is further configured to send signaling indicating one or more machine learning models for processing the PMI feedback.

28. A method of wireless communication by a user equipment (UE), comprising:
receiving a channel state information (CSI) report setting that indicates to the UE to report precoding matrix indicator (PMI) feedback determined based on a codebook corresponding to a combination of time-division multiplexed CSI reference signal (CSI-RS) or synchronization signal block (SSB) resources; and
reporting CSI with the PMI feedback associated with one or more resources in the time-division multiplexed CSI-RS or SSB resources.

29. The method of claim 28, wherein the PMI feedback, as determined according to the codebook, includes:
feedback associated with one or more subsets of the CSI-RS or SSB resources selected for the PMI feedback;
quantized combination coefficients of the CSI-RS or SSB resources;
a combined reference signal received power (RSRP) or a combined signal-to-interference-plus-noise ratio (SINR) for the combination of the CSI-RS or SSB resources; or
any combination thereof.

30. A method of wireless communication by a network entity, comprising:
sending a channel state information (CSI) report setting that indicates to a user equipment (UE) to report precoding matrix indicator (PMI) feedback based on a codebook corresponding to a combination of time-division multiplexed channel state information reference signal (CSI-RS) or synchronization signal block (SSB) resources;
sending one or more signals associated with the time-division multiplexed CSI-RS or SSB resources; and
obtaining CSI with the PMI feedback associated with at least one of the one or more signals.
